(19) United States
(12) Patent Application Publication
(10) Pub. No.: US 2025/0373304 A1
(43) Pub. Date: Dec. 4, 2025

(54) METHOD AND APPARATUS FOR CSI CODEBOOK

(71) Applicant: Samsung Electronics Co., Ltd., Suwon-si (KR)

(72) Inventors: Gilwon Lee, Prosper, TX (US); Md. Saifur Rahman, Plano, TX (US); Eko Onggosanusi, Coppell, TX (US)

(21) Appl. No.: 19/300,419

(22) Filed: Aug. 14, 2025

Related U.S. Application Data
(63) Continuation of application No. 18/156,377, filed on Jan. 18, 2023, now abandoned.
(60) Provisional application No. 63/305,916, filed on Feb. 2, 2022.
(60) Provisional application No. 63/310,386, filed on Feb. 15, 2022.
(60) Provisional application No. 63/326,621, filed on Apr. 1, 2022.
(60) Provisional application No. 63/343,856, filed on May 19, 2022.
(60) Provisional application No. 63/403,597, filed on Sep. 2, 2022.
(60) Provisional application No. 63/412,202, filed on Sep. 30, 2022.

(51) Int. Cl. H04B 7/06

(52) U.S. Cl. CPC H04B 7/0626; H04B 7/0634

(57) ABSTRACT

Apparatuses and methods for channel state information (CSI) codebook. A method for operating a user equipment (UE) includes receiving a configuration about a CSI report. The configuration includes information about N>1 groups of CSI reference signal (CSI-RS) ports and a codebook. The codebook includes a spatial-domain (SD) basis component, a frequency-domain (FD) basis component, and a coefficient component. The SD basis component includes Lᵣ basis vectors for each group r=1, . . . , N. The FD basis component includes Mᵥ basis vectors. The coefficient component includes coefficients associated with (SD, FD) basis vector pairs. The method further includes, based on the configuration, measuring the N groups of CSI-RS ports and determining the SD basis component, the FD basis component, and the coefficient component such that K₁ coefficients are non-zero and remaining coefficients are zero, where

$${K}_{1} \leq {\sum }_{r = 1}^{N} ( 2 {L}_{r} {M}_{v} ) .$$

The method further includes transmitting the CSI report including an indicator indicating locations of non-zero coefficients.

### CROSS-REFERENCE TO RELATED APPLICATION AND CLAIM OF PRIORITY

This application is a continuation of U.S. patent application Ser. No. 18/156,377 filed on Jan. 18, 2023, which claims priority under 35 U.S.C. § 119 (e) to U.S. Provisional Patent Application No. 63/305,916 filed on Feb. 2, 2022; U.S. Provisional Patent Application No. 63/310,386 filed on Feb. 15, 2022; U.S. Provisional Patent Application No. 63/326,621 filed on Apr. 1, 2022; U.S. Provisional Patent Application No. 63/343,856 filed on May 19, 2022; U.S. Provisional Patent Application No. 63/403,597 filed on Sep. 2, 2022; and U.S. Provisional Patent Application No. 63/412,202 filed on Sep. 30, 2022. The above-identified provisional patent applications are hereby incorporated by reference in their entirety.

### TECHNICAL FIELD

The present disclosure relates generally to wireless communication systems and, more specifically, to a channel state information (CSI) codebook.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for CSI codebook.

In one embodiment, a user equipment (UE) is provided. The UE includes a transceiver configured to receive a configuration about a CSI report. The configuration includes information about (i) N>1 groups of CSI reference signal (CSI-RS) ports and (ii) a codebook. The codebook includes a spatial-domain (SD) basis component, a frequency-domain (FD) basis component, and a coefficient component. The SD basis component includes Lᵣ basis vectors for each group r=1, . . . , N. The FD basis component includes Mᵥ basis vectors. The coefficient component includes coefficients associated with (SD, FD) basis vector pairs. The UE further includes a processor operably coupled to the transceiver. The processor, based on the configuration, is configured to measure the N groups of CSI-RS ports and determine the SD basis component, the FD basis component, and the coefficient component such that K₁ coefficients are non-zero and remaining coefficients are zero, where

$${K}_{1} \leq {\sum }_{r = 1}^{N} ( 2 {L}_{r} {M}_{v} ) .$$

The transceiver is further configured to transmit the CSI report including an indicator indicating locations of non-zero coefficients.

In another embodiment, a base station (BS) is provided. The BS includes a processor configured to generate a configuration about a CSI report. The configuration including information about (i) N>1 groups of CSI-RS ports and (ii) a codebook. The codebook includes a SD basis component, a FD basis component, and a coefficient component. The SD basis component includes Lᵣ basis vectors for each group r=1, . . . , N. The FD basis component includes Mᵥ basis vectors. The coefficient component includes coefficients associated with (SD, FD) basis vector pairs. The BS further includes a transceiver operably coupled to the processor. The transceiver is configured to transmit the configuration; transmit on the N groups of CSI-RS ports; and receive the CSI report including an indicator indicating locations of non-zero coefficients from among the SD basis component, the FD basis component, and the coefficient component that are based on the N groups of CSI-RS ports. K₁ coefficients are non-zero and remaining coefficients are zero, where

$${K}_{1} \leq {\sum }_{r = 1}^{N} ( 2 {L}_{r} {M}_{v} ) .$$

In yet another embodiment, a method for operating a UE is provided. The method includes receiving a configuration about a CSI report. The configuration includes information about (i) N>1 groups of CSI-RS ports and (ii) a codebook. The codebook includes a SD basis component, a FD basis component, and a coefficient component. The SD basis component includes Lᵣ basis vectors for each group r=1, . . . , N. The FD basis component includes Mᵥ basis vectors. The coefficient component includes coefficients associated with (SD, FD) basis vector pairs. The method further includes, based on the configuration, measuring the N groups of CSI-RS ports and determining the SD basis component, the FD basis component, and the coefficient component such that K₁ coefficients are non-zero and remaining coefficients are zero, where

$${K}_{1} \leq {\sum }_{r = 1}^{N} ( 2 {L}_{r} {M}_{v} ) .$$

The method further includes transmitting the CSI report including an indicator indicating locations of non-zero coefficients.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates a transmitter block diagram for a physical downlink shared channel (PDSCH) in a subframe according to embodiments of the present disclosure;

FIG. 7 illustrates a receiver block diagram for a PDSCH in a subframe according to embodiments of the present disclosure;

FIG. 8 illustrates a transmitter block diagram for a physical uplink shared channel (PUSCH) in a subframe according to embodiments of the present disclosure;

FIG. 9 illustrates a receiver block diagram for a PUSCH in a subframe according to embodiments of the present disclosure;

FIG. 10 illustrates an example antenna blocks or arrays forming beams according to embodiments of the present disclosure;

FIG. 11 illustrates an example distributed multiple-input multiple-output (D-MIMO) system according to embodiments of the present disclosure;

FIG. 12 illustrates an example D-MIMO system according to embodiments of the present disclosure;

FIG. 13 illustrates an example antenna port layout according to embodiments of the present disclosure;

FIG. 14 illustrates a three-dimensional (3D) grid of oversampled discrete Fourier transform (DFT) beams according to embodiments of the present disclosure;

FIG. 15 illustrates two new codebooks according to embodiments of the present disclosure;

FIG. 16 illustrates an example D-MIMO where each transmit/receive point (TRP) has a single antenna panel according to embodiments of the present disclosure;

FIG. 17 illustrates an example D-MIMO where each TRP has multiple antenna panels according to embodiments of the present disclosure;

FIG. 18 illustrates an example D-MIMO where each TRP can be a single panel (SP) or multiple panel (MP) according to embodiments of the present disclosure;

FIG. 19 illustrates an example signal flow for uplink (UL)-to-downlink (DL) channel mapping training according to embodiments of the present disclosure; and

FIG. 20 illustrates an example block diagram where a UL channel to DL channel mapping is trained through over-the-air (OTA) signaling according to embodiments of the present disclosure.

### DETAILED DESCRIPTION

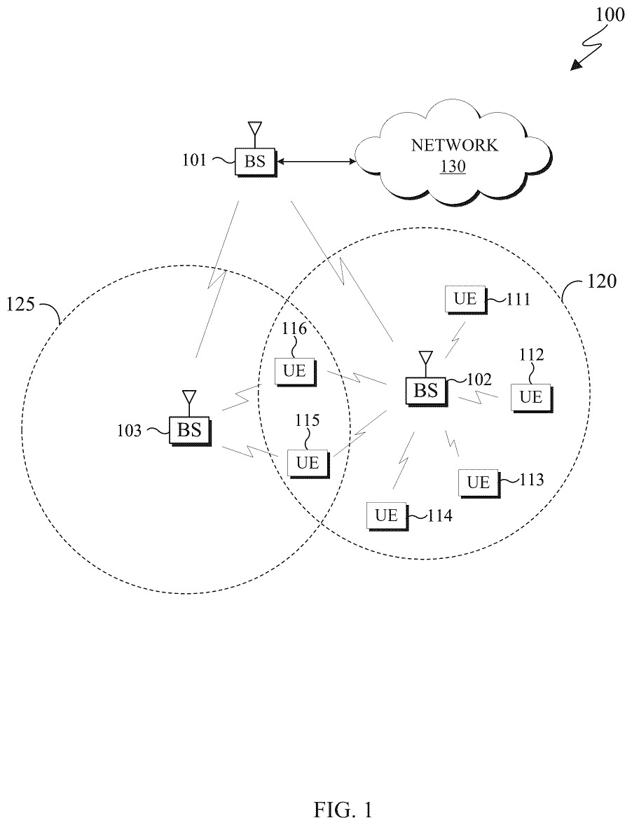

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.0.0, “E-UTRA, Physical channels and modulation” (herein “REF 1”); 3GPP TS 36.212 v17.0.0, “E-UTRA, Multiplexing and Channel coding” (herein “REF 2”); 3GPP TS 36.213 v17.0.0, “E-UTRA, Physical Layer Procedures” (herein “REF 3”); 3GPP TS 36.321 v17.0.0, “E-UTRA, Medium Access Control (MAC) protocol specification” (herein “REF 4”); 3GPP TS 36.331 v17.0.0, “E-UTRA, Radio Resource Control (RRC) protocol specification” (herein “REF 5”); 3GPP TS 38.211 v17.0.0, “NR, Physical Channels and Modulation” (herein “REF 6”); 3GPP TS 38.212 v17.0.0, “NR, Multiplexing and channel coding” (herein “REF 7”); 3GPP TS 38.213 v17.0.0, “NR, Physical Layer Procedures for Control” (herein “REF 8”); 3GPP TS 38.214 v17.0.0; “NR, Physical Layer Procedures for Data” (herein “REF 9”); 3GPP TS 38.215 v17.0.0; “NR, Physical Layer Measurements” (herein “REF 10”); 3GPP TS 38.321 v17.0.0; “NR, Medium Access Control (MAC) Protocol Specification” (herein “REF 11”); 3GPP TS 38.331 v17.0.0; “NR, Radio Resource Control (RRC) Protocol Specification” (herein “REF 12”); and RP-213599 “Study on Artificial Intelligence (AI)/Machine Learning (ML) for NR Air Interface” (herein “REF 13”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for CSI codebook. In certain embodiments, one or more of the BSs 101-103 include circuitry, programing, or a combination thereof for CSI codebook.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

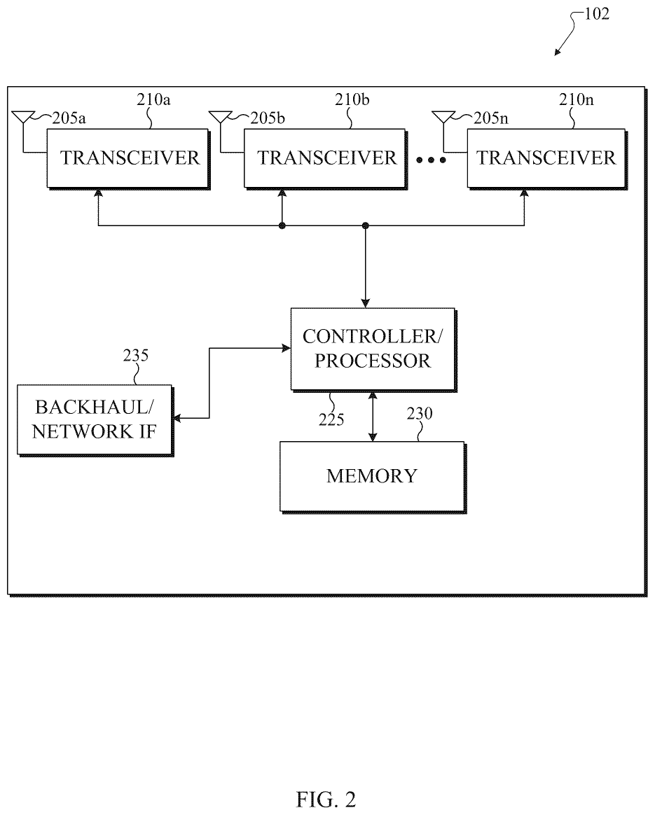

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for uplink transmission in full duplex systems. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

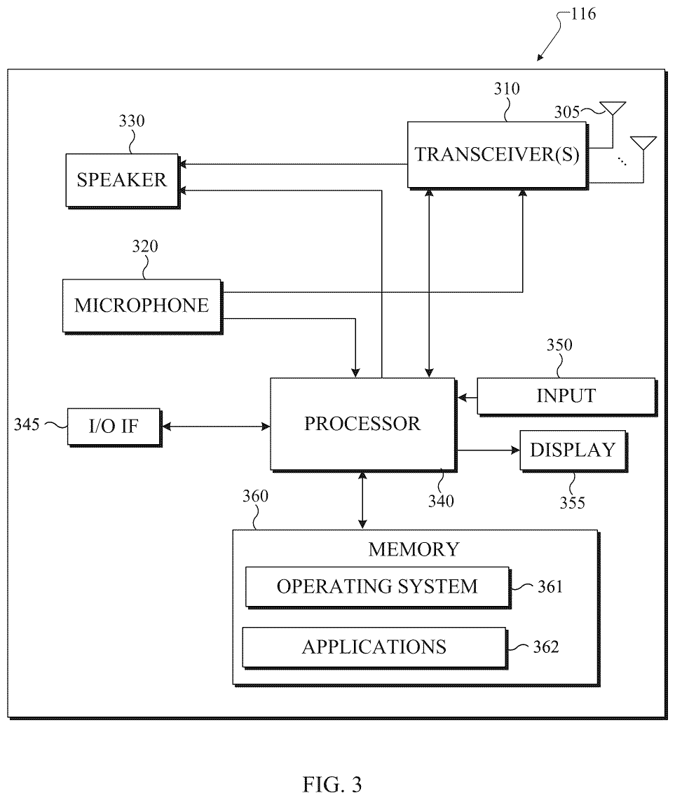

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

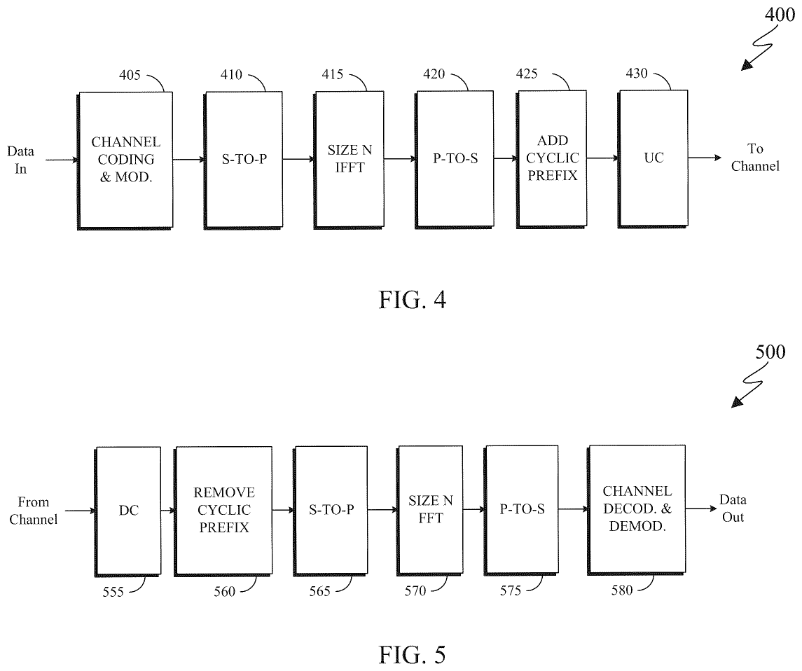

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support CSI codebook as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE system, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH)—see also REF 3. An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes

$${N}_{s c}^{R B}$$

sub-carriers, or resource elements (REs), such as 12 REs. A unit of one RB over one subframe is referred to as a PRB. A UE can be allocated M_{PDSCH} RBs for a total of

$${M}_{s c}^{P D S C H} = {M}_{P D S C H} \cdot {N}_{s c}^{R B}$$

REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

$${N}_{s y m b}^{UL}$$

An UL subframe includes two slots. Each slot includes symbols for transmitting data information, UCI, DMRS, or SRS. A frequency resource unit of an UL system BW is an RB. A UE is allocated N_{RB} RBs for a total of

$${N}_{R B} \cdot {N}_{s c}^{R B}$$

REs for a transmission BW. For a PUCCH, N_{RB}=1. A last subframe symbol can be used to multiplex SRS transmissions from one or more UEs. A number of subframe symbols that are available for data/UCI/DMRS transmission is

$${N}_{symb} = 2 \cdot ( {N}_{symb}^{UL} - 1 ) - {N}_{S R S} ,$$

where N_{SRS}=1 if a last subframe symbol is used to transmit SRS and N_{SRS}=0 otherwise.

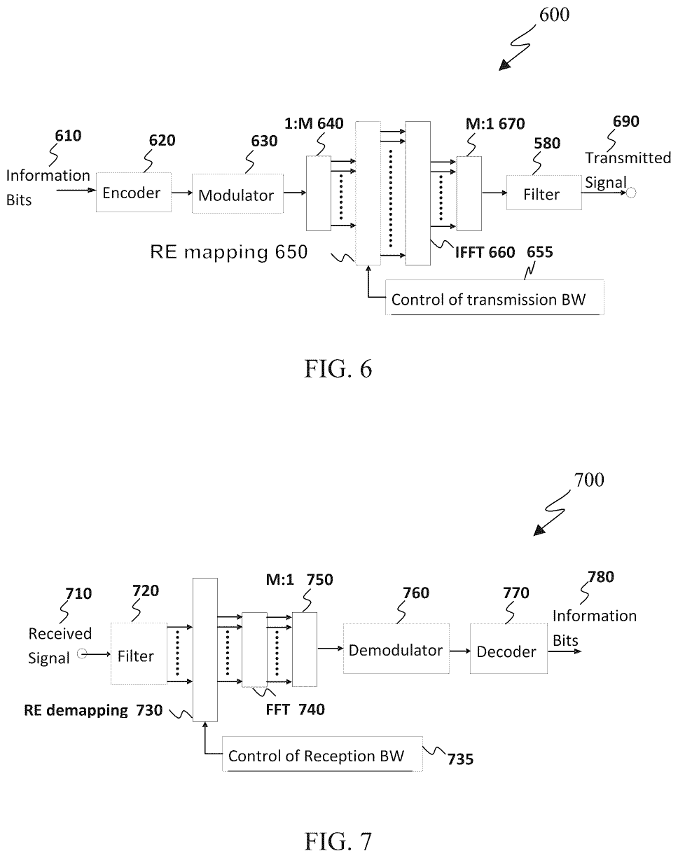

FIG. 6 illustrates a transmitter block diagram 600 for a PDSCH in a subframe according to embodiments of the present disclosure. The embodiment of the transmitter block diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the transmitter block diagram 600.

As shown in FIG. 6, information bits 610 are encoded by encoder 620, such as a turbo encoder, and modulated by modulator 630, for example using quadrature phase shift keying (QPSK) modulation. A serial to parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse fast Fourier transform (IFFT), the output is then serialized by a parallel to serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates a receiver block diagram 700 for a PDSCH in a subframe according to embodiments of the present disclosure. The embodiment of the diagram 700 illustrated in FIG. 7 is for illustration only. One or more of the components illustrated in FIG. 7 can be implemented in specialized circuitry configured to perform the noted functions or one or more of the components can be implemented by one or more processors executing instructions to perform the noted functions. FIG. 7 does not limit the scope of this disclosure to any particular implementation of the diagram 700.

As shown in FIG. 7, a received signal 710 is filtered by filter 720, REs 730 for an assigned reception BW are selected by BW selector 735, unit 740 applies a fast Fourier transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

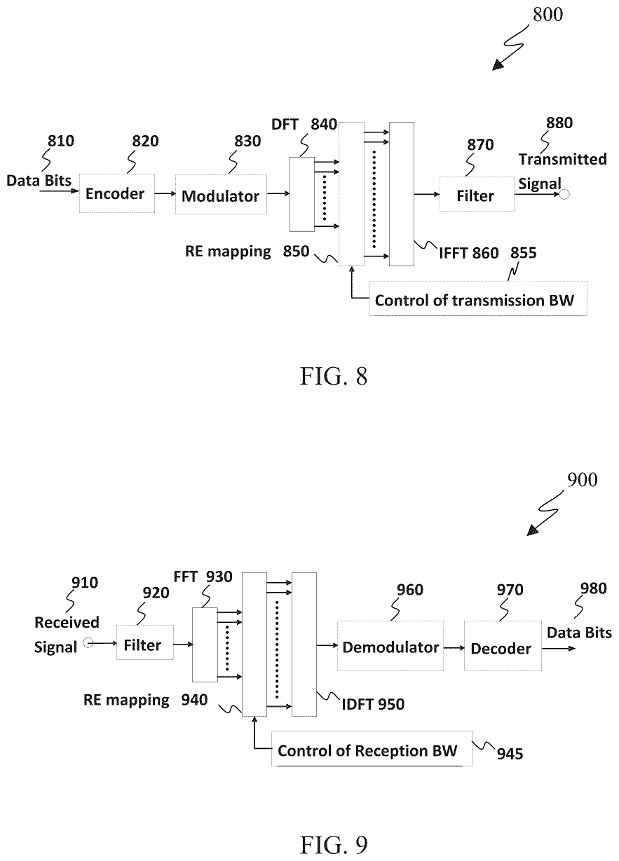

FIG. 8 illustrates a transmitter block diagram 800 for a PUSCH in a subframe according to embodiments of the present disclosure. The embodiment of the block diagram 800 illustrated in FIG. 8 is for illustration only. One or more of the components illustrated in FIG. 6 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, information data bits 810 are encoded by encoder 820, such as a turbo encoder, and modulated by modulator 830. A discrete Fourier transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates a receiver block diagram 900 for a PUSCH in a subframe according to embodiments of the present disclosure. The embodiment of the block diagram 900 illustrated in FIG. 9 is for illustration only. One or more of the components illustrated in FIG. 9 can be implemented in specialized circuitry configured to perform the noted functions or one or more of the components can be implemented by one or more processors executing instructions to perform the noted functions. FIG. 9 does not limit the scope of this disclosure to any particular implementation of the block diagram 900.

As shown in FIG. 9, a received signal 910 is filtered by filter 920. Subsequently, after a cyclic prefix is removed (not shown), unit 930 applies an FFT, REs 940 corresponding to an assigned PUSCH reception BW are selected by a reception BW selector 945, unit 950 applies an inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

In next generation cellular systems, various use cases are envisioned beyond the capabilities of LTE system. Termed 5G or the fifth-generation cellular system, a system capable of operating at sub-6 GHZ and above-6 GHz (for example, in mmWave regime) becomes one of the requirements. In 3GPP TR 22.891, 74 5G use cases have been identified and described; those use cases can be roughly categorized into three different groups. A first group is termed “enhanced mobile broadband (eMBB),” targeted to high data rate services with less stringent latency and reliability requirements. A second group is termed “ultra-reliable and low latency (URLL)” targeted for applications with less stringent data rate requirements, but less tolerant to latency. A third group is termed “massive MTC (mMTC)” targeted for large number of low-power device connections such as 1 million per km² with less stringent the reliability, data rate, and latency requirements.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

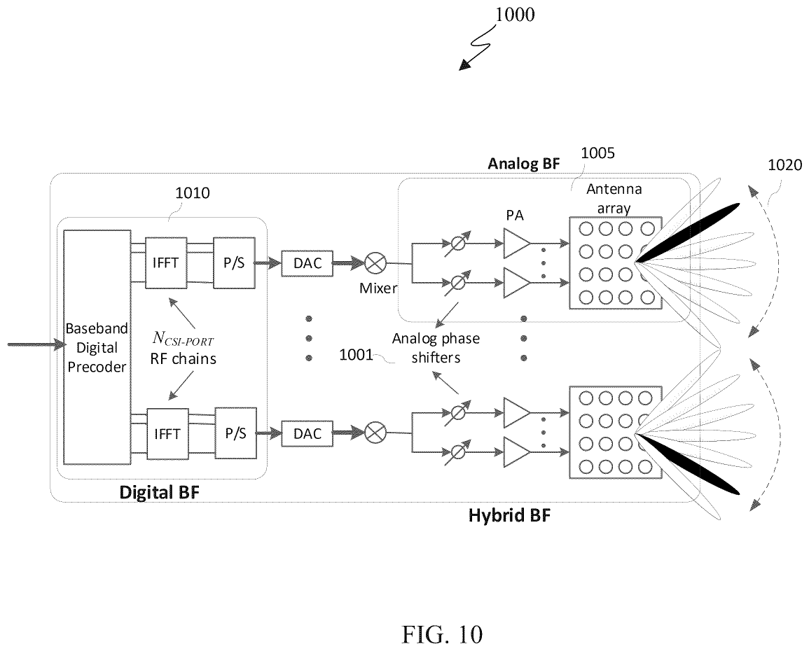

FIG. 10 illustrates an example antenna blocks or arrays 1000 according to embodiments of the present disclosure. The embodiment of the antenna blocks or arrays 1000 illustrated in FIG. 10 is for illustration only. FIG. 10 does not limit the scope of this disclosure to any particular implementation of the antenna blocks or arrays.

For mmWave bands, although the number of antenna elements can be larger for a given form factor, the number of CSI-RS ports-which can correspond to the number of digitally precoded ports—tends to be limited due to hardware constraints (such as the feasibility to install a large number of ADCs/DACs at mm Wave frequencies) as illustrated in FIG. 10. In this case, one CSI-RS port is mapped onto a large number of antenna elements which can be controlled by a bank of analog phase shifters 1001. One CSI-RS port can then correspond to one sub-array which produces a narrow analog beam through analog beamforming 1005. This analog beam can be configured to sweep across a wider range of angles 1020 by varying the phase shifter bank across symbols or subframes. The number of sub-arrays (equal to the number of RF chains) is the same as the number of CSI-RS ports N_{CSI-PORT}. A digital beamforming unit 1010 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

At lower frequency bands such as FR1 or particularly sub-1 GHz band, on the other hand, the number of antenna elements cannot be increased in a given form factor due to large wavelength. As an example, for the case of the wavelength size (A) of the center frequency 600 MHz (which is 50 cm), it requires 4 m for uniform-linear-array (ULA) antenna panel of 16 antenna elements with the half-wavelength distance between two adjacent antenna elements. Considering a plurality of antenna elements is mapped to one digital port in practical cases, the required size for antenna panels at gNB to support a large number of antenna ports, e.g., 32 CSI-RS ports, becomes very large in such low frequency bands, and it leads to the difficulty of deploying 2-D antenna arrays within the size of a conventional form factor. This can result in a limited number of physical antenna elements and, subsequently CSI-RS ports, that can be supported at a single site and limit the spectral efficiency of such systems.

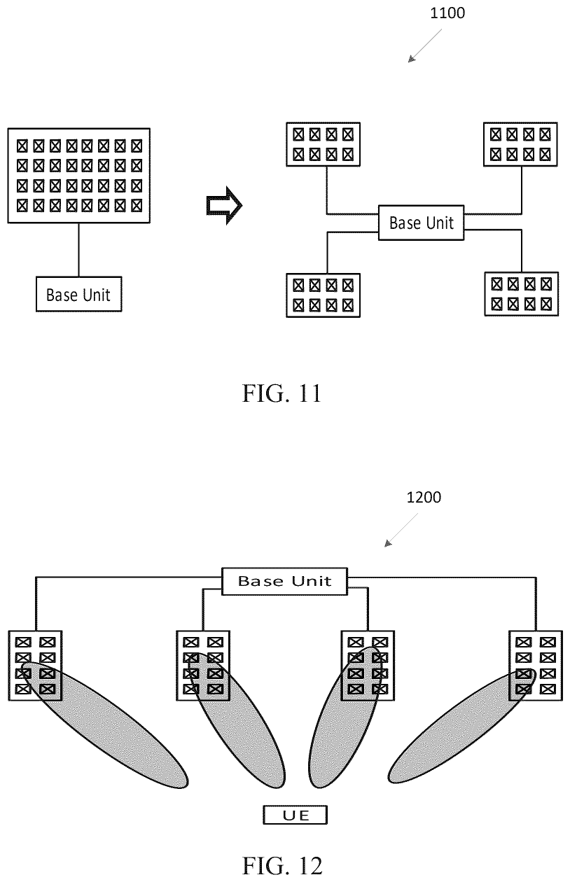

FIG. 11 illustrates an example system for D-MIMO 1100 according to embodiments of the present disclosure. The embodiment of the example system for D-MIMO 1100 illustrated in FIG. 11 is for illustration only. FIG. 112 does not limit the scope of this disclosure to any particular implementation of the example system for D-MIMO.

As illustrated in FIG. 11, one approach to resolving the issue described above is to form multiple TRPs (multi-TRP) or RRHs with a small number of antenna ports instead of integrating all of the antenna ports in a single panel (or at a single site) and to distribute the multiple panels in multiple locations/sites (or TRPs, RRHs). This approach, the concept of distributed MIMO (D-MIMO), is shown in FIG. 11.

FIG. 12 illustrates an example system for D-MIMO 1200 according to embodiments of the present disclosure. The embodiment of the example system for D-MIMO 1200 illustrated in FIG. 12 is for illustration only. FIG. 12 does not limit the scope of this disclosure to any particular implementation of the example system for D-MIMO.

As illustrated in FIG. 12, the multiple TRPs at multiple locations can still be connected to a single base unit, and thus the signal transmitted/received via multiple distributed TRPs can be processed in a centralized manner through the single base unit.

Note that although low frequency band systems (sub-1 GHz band) have been mentioned as a motivation for distributed MIMO (or mTRP), the distributed MIMO technology is frequency-band-agnostic and can be useful in mid-(sub-6 GHZ) and high-band (above-6 GHz) systems in addition to low-band (sub-1 GHz) systems.

The terminology “distributed MIMO” is used as an illustrative purpose, it can be considered under another terminology such as multi-TRP, mTRP, cell-free network, and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI or calibration coefficient reporting setting.

“CSI or calibration coefficient reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band”. Alternatively, CSI or calibration coefficient reporting band can include only a collection of subbands within the DL system bandwidth. This can also be termed “partial band”.

The term “CSI or calibration coefficient reporting band” is used only as an example for representing a function. Other terms such as “CSI or calibration coefficient reporting subband set” or “CSI or calibration coefficient reporting bandwidth” can also be used.

In terms of UE configuration, a UE can be configured with at least one CSI or calibration coefficient reporting band. This configuration can be semi-static (via higher-layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

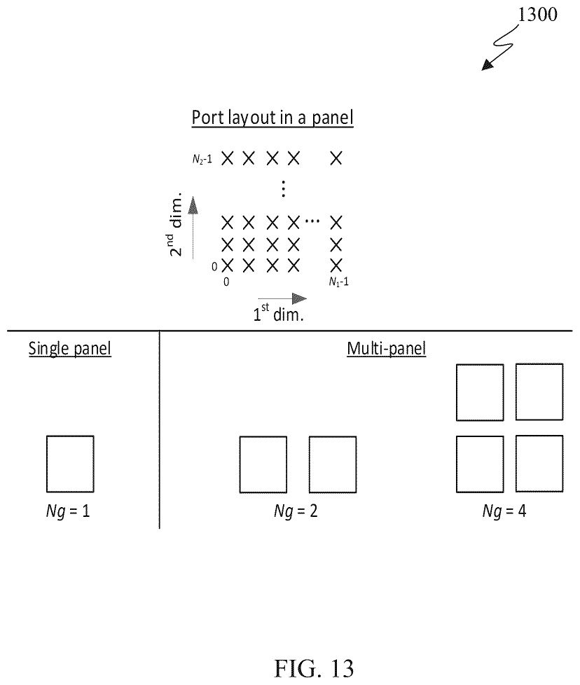

FIG. 13 illustrates an example antenna port layout 1300 according to embodiments of the present disclosure. The embodiment of the antenna port layout 1300 illustrated in FIG. 13 is for illustration only. FIG. 13 does not limit the scope of this disclosure to any particular implementation of the antenna port layout.

As illustrated in FIGS. 13, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 13 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB. When there are multiple antenna panels (N_{g}>1), we assume that each panel is dual-polarized antenna ports with N₁ and N₂ ports in two dimensions. This is illustrated in FIG. 13. Note that the antenna port layouts may or may not be the same in different antenna panels.

In the present disclosure CSI codebook designs to support distributed MIMO or multi-TRP (mTRP) operations are provided.

Various embodiments for CSI codebook designs and reporting for distributed MIMO or multi-TRP operations in wireless networks are described herein.

CSI enhancement described in Rel-18 MIMO considers Rel-16/17 Type-II CSI codebook refinements to support mTRP coherent joint transmission (C-JT) operations by considering performance-and-overhead trade-off. The Rel-16/17 Type-II CSI codebook has three components W₁, W₂, and W_{f}. Among them, W₂ is the component that could induce large CSI feedback overhead especially in mTRP C-JT operations. In the present disclosure, several embodiments relating to W₂ in addition to W₁ and W_{f} are provided to alleviate amount of CSI reporting overhead to have good performance-and-overhead trade-off for C-JT operations.

In one example, the antenna architecture of a D-MIMO or CJT system is structured. For example, the antenna structure at each RRH (or TRP) is dual-polarized (single or multi-panel as shown in FIG. 13. The antenna structure at each RRH/TRP can be the same. Alternatively, the antenna structure at an RRH/TRP can be different from another RRH/TRP. Likewise, the number of ports at each RRH/TRP can be the same. Alternatively, the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

A structured antenna architecture is assumed in the rest of the disclosure. For simplicity, it is assumed that each RRH/TRP is equivalent to a panel, although, an RRH/TRP can have multiple panels in practice. The disclosure however is not restrictive to a single panel assumption at each RRH/TRP, and can easily be extended (covers) the case when an RRH/TRP has multiple antenna panels.

In one embodiment, an RRH constitutes (or corresponds to or is equivalent to) at least one of the following:
In one example, an RRH corresponds to a TRP.
In one example, an RRH or TRP corresponds to a CSI-RS resource. A UE is configured with K=N_{RRH}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.
In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{RRH} resource groups. The information about the resource grouping can be provided together with the CSI-RS resource setting/configuration, or with the CSI reporting setting/configuration, or with the CSI-RS resource configuration.
In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.
In one example, an RRH or TRP corresponds to one or more examples described herein depending on a configuration. For example, this configuration can be explicit via a parameter (e.g., an RRC parameter). Alternatively, it can be implicit.
   a. In one example, when implicit, it could be based on the value of K. For example, when K>1 CSI-RS resources, an RRH corresponds to one or more examples described above, and when K=1 CSI-RS resource, an RRH corresponds to one or more examples described above.
   b. In another example, the configuration could be based on the configured codebook. For example, an RRH corresponds to a CSI-RS resource or resource group when the codebook corresponds to a decoupled codebook (modular or separate codebook for each RRH), and an RRH corresponds to a subset (or a group) of CSI-RS ports when codebook corresponds to a coupled (joint or coherent) codebook (one joint codebook across TRPs/RRHs).

In one example, when RRH or TRP maps (or corresponds to) a CSI-RS resource or resource group, and a UE can select a subset of RRHs (resources or resource groups) and report the CSI for the selected RRHs (resources or resource groups), the selected RRHs can be reported via an indicator. For example, the indicator can be a CRI or a PMI (component) or a new indicator.

In one example, when RRH or TRP maps (or corresponds to) a CSI-RS port group, and a UE can select a subset of RRHs (port groups) and report the CSI for the selected RRHs (port groups), the selected RRHs can be reported via an indicator. For example, the indicator can be a CRI or a PMI (component) or a new indicator.

In one example, when multiple (K>1) CSI-RS resources are configured for N_{RRH} RRHs, a decoupled (modular) codebook is used/configured, and when a single (K=1) CSI-RS resource for N_{RRH} RRHs, a joint codebook is used/configured.

As described in U.S. Pat. No. 10,659,118, issued May 19, 2020, and titled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination-based Type II CSI reporting framework is extended to include a frequency dimension in addition to the first and second antenna port dimensions.

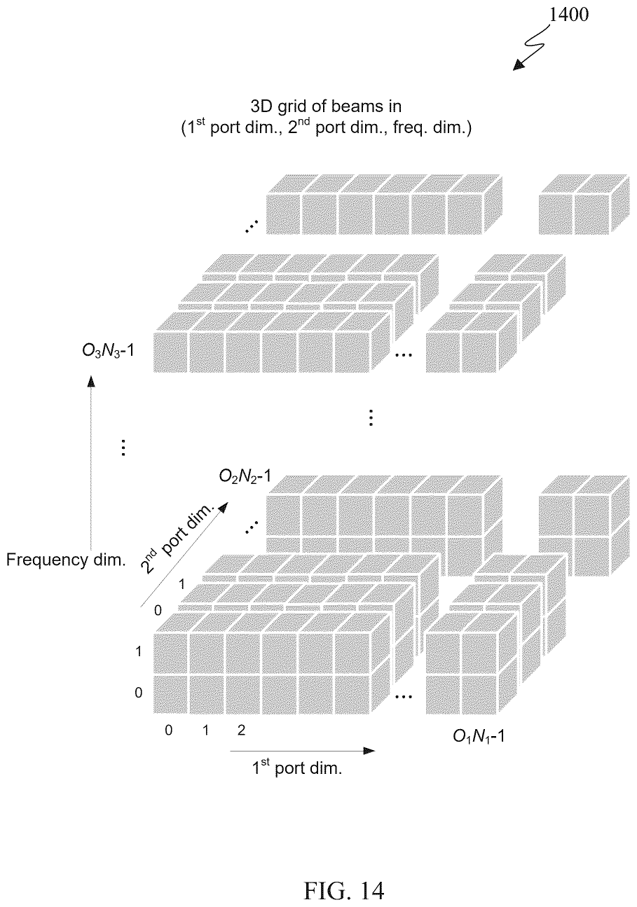

FIG. 14 illustrates a 3D grid of oversampled DFT beams 1400 according to embodiments of the present disclosure. The embodiment of the 3D grid of oversampled DFT beams 1400 illustrated in FIG. 14 is for illustration only. FIG. 14 does not limit the scope of this disclosure to any particular implementation of the 3D grid of oversampled DFT beams.

As illustrated, FIG. 14 shows a 3D grid 1400 of the oversampled DFT beams (1st port dim., 2nd port dim., freq. dim.) in which
1st dimension is associated with the 1st port dimension,
2nd dimension is associated with the 2nd port dimension, and
3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REF8, a UE is configured with higher layer parameter codebookType set to ‘typeII-PortSelection-r16’ for an enhanced Type II CSI reporting in which the pre-coders for all SBs and for a given layer l=1, . . . , v, where v is the associated RI value, is given by either

$${W}^{l} = A {C}_{l} {B}^{H} = {[ {a}_{0} {a}_{1} … {a}_{L − 1} ] [ \begin{matrix}{c}_{l , 0 , 0} & {c}_{l , 0 , 1} & ⋯ & {c}_{l , 0 , M − 1} \\ {c}_{l , 1 , 0} & {c}_{l , 1 , 1} & ⋯ & {c}_{l , 1 , M − 1} \\ ⋮ & ⋮ & ⋮ & ⋮ \\ {c}_{l , L − 1 , 0} & {c}_{l , L − 1 , 1} & ⋯ & {c}_{l , L − 1 , M − 1}\end{matrix} ] [ {b}_{0} {b}_{1} … {b}_{M − 1} ]}^{H} = {\sum }_{f = 0}^{M − 1} {\sum }_{i = 0}^{L − 1} {c}_{l , i , f} ( {a}_{i} {b}_{f}^{H} ) = {\sum }_{i = 0}^{L − 1} {\sum }_{f = 0}^{M − 1} {c}_{l , i , f} ( {a}_{i} {b}_{f}^{H} ) , \qquad ( Eq . 1 )$$

$$or$$

$${W}^{l} = [ \begin{matrix}A & 0 \\ 0 & A\end{matrix} ] {C}_{l} {B}^{H} = {[ \begin{matrix}{a}_{0} {a}_{1} … {a}_{L − 1} & 0 \\ 0 & {a}_{0} {a}_{1} … {a}_{L − 1}\end{matrix} ] [ \begin{matrix}{c}_{l , 0 , 0} & {c}_{l , 0 , 1} & ⋯ & {c}_{l , 0 , M − 1} \\ {c}_{l , 1 , 0} & {c}_{l , 1 , 1} & ⋯ & {c}_{l , 1 , M − 1} \\ ⋮ & ⋮ & ⋮ & ⋮ \\ {c}_{l , L − 1 , 0} & {c}_{l , L − 1 , 1} & ⋯ & {c}_{l , L − 1 , M − 1}\end{matrix} ] [ {b}_{0} {b}_{1} … {b}_{M − 1} ]}^{H} = [ \begin{matrix}{\sum }_{f = 0}^{M − 1} {\sum }_{i = 0}^{L − 1} {c}_{l , i , f} ( {a}_{i} {b}_{f}^{H} ) \\ {\sum }_{f = 0}^{M − 1} {\sum }_{i = 0}^{L − 1} {c}_{l , i + L , f} ( {a}_{i} {b}_{f}^{H} )\end{matrix} ] , \qquad ( Eq . 2 )$$

where
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
αᵢ is a 2N₁N₂×1 (Eq. 1) or N₁N₂×1 (Eq. 2) column vector, or

$$\frac{{P}_{CSIRS}}{2} \times 1$$

port selection column vector, where a port selection vector is a defined as a vector which contains a value of 1 in one element and zeros elsewhere
b_{f} is a N₃×1 column vector,
c_{l,i,f} is a complex coefficient.

In a variation, when the UE reports a subset K<2 LM coefficients (where K is either fixed, configured by the gNB or reported by the UE), then the coefficient c_{l,i,f} in precoder equations Eq. 1 or Eq. 2 is replaced with x_{l,i,f}×c_{l,if}, where
x_{l,i,f}=1 if the coefficient c_{l,i,f} is reported by the UE according to some embodiments of this disclosure.
x_{l,i,f}=0 otherwise (i.e., c_{l,i,f} is not reported by the UE).

The indication whether x_{l,i,f}=1 or 0 is according to some embodiments of this disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (v=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} .$$

### If

$$L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by:

$${w}_{f} = {[ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & … & {e}^{j \frac{2 π . ( {N}_{3} − 1 ) {n}_{3 , l}^{( f )}}{{O}_{3} {N}_{3}}}\end{matrix} \text{} ]}^{T} .$$

When O₃=1, the FD basis vector for layer l∈{1, . . . , v} (where v is the RI or rank value) is given by:

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} ,$$

$$where$$

$${y}_{t , l}^{( f )} = {e}^{j \frac{2 π t {n}_{3 , l}^{( f )}}{{N}_{3}}} and {n}_{3 , l} = [ {n}_{3 , l}^{( 0 )} , … , {n}_{3 , l}^{( M - 1 )} ]$$

$$where$$

$${n}_{3 , l}^{( f )} ∈ \{ 0 , 1 , … , {N}_{3} - 1 \} .$$

In another example, discrete cosine transform DCT basis is used to construct/report basis B for the 3^{rd} dimension. The m-th column of the DCT compression matrix is simply given by:

$${[ {W}_{f} ]}_{n m} = \{ \begin{matrix}\frac{1}{\sqrt{K}} , n = 0 \\ \sqrt{\frac{2}{K}} cos \frac{π ( 2 m + 1 ) n}{2 K} , n = 1 , … K − 1\end{matrix} , and K = {N}_{3} , and m = 0 , … , {N}_{3} − 1 .$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W′ can be described as follows.

$$W = {A}_{l} {C}_{l} {B}_{l}^{H} = {W}_{1} {\tilde{W}}_{2} {W}_{f}^{H} , \qquad ( Eq . 5 )$$

where A=W₁ corresponds to the Rel. 15 W₁ in Type II CSI codebook [REF8], and B=W_{f}.

The Cₗ=\tilde{W}₂ matrix consists of all the required linear combination coefficients (e.g., amplitude and phase or real or imaginary). Each reported coefficient (c_{l,i,f}=P_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as

$${p}_{l , i , f} = {p}_{l , i , f}^{( 1 )} {p}_{l , i , f}^{( 2 )}$$

where

$${p}_{l , i , f}^{( 1 )}$$

is a reference or first amplitude which is reported using an A1-bit amplitude codebook where A1 belongs to {2, 3, 4}, and

$${p}_{l , i , f}^{( 2 )}$$

is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=┌β×2 LM┐<2 LM and β is higher layer configured. The remaining 2 LM−K_{NZ} coefficients that are not reported by the UE are assumed to be zero. The following quantization scheme is used to quantize/report the K_{NZ} NZ coefficients.
UE reports the following for the quantization of the NZ coefficients in \tilde{W}₂
   a. A X-bit indicator for the strongest coefficient index (i*, f*), where X=┌log₂ K_{NZ}┐ or ┌log₂ 2L┐.
      i. Strongest coefficient c_{l,i*,f*}=1 (hence its amplitude/phase are not reported)
   b. Two antenna polarization-specific reference amplitudes are used.
      i. For the polarization associated with the strongest coefficient c_{l,i*,f*}=1, since the reference amplitude

$${p}_{l , i , f}^{( 1 )} = 1 ,$$

it is not reported
ii. For the other polarization, reference amplitude

$${p}_{l , i , f}^{( 1 )}$$

is quantized to 4 bits
   1. The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

c. For {c_{l,i,f}, (i,f)≠(i*,f*)}:
   i. For each polarization, differential amplitudes

$${p}_{l , i , f}^{( 2 )}$$

of the coefficients calculated relative to the associated polarization-specific reference amplitude and quantized to 3 bits
   1. The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

2. Note: The final quantized amplitude p_{l,i,f} is given by

$${p}_{l , i , f}^{( 1 )} \times {p}_{l , i , f}^{( 2 )}$$

ii. Each phase is quantized to either 8 PSK (Nₚₕ=8) or 16 PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude

$${p}_{l , i , f}^{( 1 )} = {p}_{l , {r}^{*}}^{( 1 )} = 1.$$

For the other polarization r∈{0,1} and r≠r*, we have

$$r = ( ⌊ \frac{{i}^{*}}{L} ⌋ + 1 ) mod 2$$

and the reference amplitude

$${p}_{l , i , f}^{( 1 )} = {p}_{l , r}^{( 1 )}$$

is quantized (reported) using the 4-bit amplitude codebook mentioned above.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1,2} and p is higher-layer configured from

$$\{ \frac{1}{4} , \frac{1}{2} \} .$$

In one example, the p value is higher-layer configured for rank 1-2 CSI reporting. For rank >2 (e.g., rank 3-4), the p value (denoted by v₀) can be different. In one example, for rank 1-4, (p, v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} , i . e . , M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In one example, M is replaced with My to show its dependence on the rank value v, hence p is replaced with pᵥ, v∈{1,2} and v₀ is replaced with pᵥ, v∈{3,4}.

A UE can be configured to report Mᵥ FD basis vectors in one-step from N₃ basis vectors freely (independently) for each layer l∈{1, . . . , v} of a rank v CSI reporting. Alternatively, a UE can be configured to report Mᵥ FD basis vectors in two-step as follows.
In step 1, an intermediate set (InS) comprising

$${N}_{3}^{′} < {N}_{3}$$

basis vectors is selected/reported, wherein the InS is common for all layers.
In step 2, for each layer l∈{1, . . . , v} of a rank v CSI reporting, Mᵥ FD basis vectors are selected/reported freely (independently) from

$${N}_{3}^{′}$$

basis vectors in the InS.

In one example, one-step method is used when N₃≤19 and two-step method is used when N₃>19. In one example,

$${N}_{3}^{′} = ⌈ α {M}_{υ} ⌉$$

where α>1 is either fixed (to 2 for example) or configurable.

The codebook parameters used in the DFT based frequency domain compression (Eq. 5) are (L, pᵥ for v∈{1,2}, pᵥ for v∈{3,4}, β, α, Nₚₕ). The set of values for these codebook parameters are as follows.
L: the set of values is {2,4} in general, except L∈{2,4,6} for rank 1-2, 32 CSI-RS antenna ports, and R=1.
(pᵥ for v∈{1,2}, pᵥ for

$$υ ∈ \{ 3 , 4 \} ) ∈ \{ ( \frac{1}{2} , \frac{1}{4} ) , ( \frac{1}{4} , \frac{1}{4} ) , ( \frac{1}{4} , \frac{1}{8} ) \} .$$

$$β ∈ \{ \frac{1}{4} , \frac{1}{2} , \frac{3}{4} \} .$$

α=2
Nₚₕ=16.
   The set of values for these codebook parameters are as in Table 1.

TABLE 1

| | | p_{υ} | | |
|---|---|---|---|---|
| | | υ | υ | |
| paramCombination | L | ∈ {1, 2} | ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook), M∈{1,2},

$$L = \frac{{K}_{1}}{2}$$

where K₁=α×P_{CSIRS}, and codebook parameters (M, α, β) are configured from Table 2.

TABLE 2

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The above-mentioned framework (Eq. 5) represents the precoding-matrices for multiple (N₃) FD units using a linear combination (double sum) over 2L (or K₁) SD beams/ports and Mᵥ FD beams. This framework can also be used to represent the precoding-matrices in time domain (TD) by replacing the FD basis matrix W_{f} with a TD basis matrix Wₜ, wherein the columns of Wₜ comprises Mᵥ TD beams that represent some form of delays or channel tap locations. Hence, a precoder W^{l} can be described as follows.

$$W = {A}_{l} {C}_{l} {B}_{l}^{H} = {W}_{1} {\tilde{W}}_{2} {W}_{t}^{H} , \qquad ( Eq . 5 A )$$

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

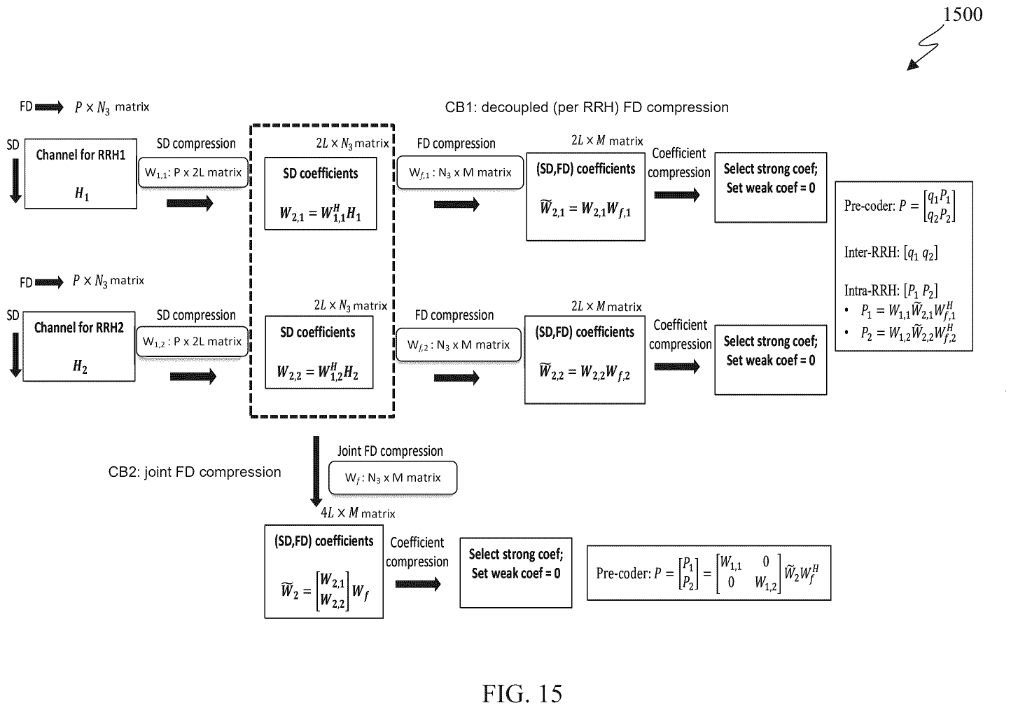

FIG. 15 illustrates an example of two new codebooks 1500 according to embodiments of the present disclosure. The embodiment of the two new codebooks 1500 illustrated in FIG. 15 is for illustration only. FIG. 15 does not limit the scope of this disclosure to any particular implementation of the two new codebooks.

In one example, the codebook for the CSI report is according to at least one of the following examples.

In one example, the codebook can be a Rel. 15 Type I single-panel codebook (cf. 5.2.2.2.1, TS 38.214).

In one example, the codebook can be a Rel. 15 Type I multi-panel codebook (cf. 5.2.2.2.2, TS 38.214).

In one example, the codebook can be a Rel. 15 Type II codebook (cf. 5.2.2.2.3, TS 38.214).

In one example, the codebook can be a Rel. 15 port selection Type II codebook (cf. 5.2.2.2.4, TS 38.214).

In one example, the codebook can be a Rel. 16 enhanced Type II codebook (cf. 5.2.2.2.5, TS 38.214).

In one example, the codebook can be a Rel. 16 enhanced port selection Type II codebook (cf. 5.2.2.2.6, TS 38.214).

In one example, the codebook can be a Rel. 17 further enhanced port selection Type II codebook (cf. 5.2.2.2.7, TS 38.214).

In one example, the codebook is a new codebook for C-JT CSI reporting.
a. In one example, the new codebook is a decoupled codebook comprising the following components: (called ‘CB1’ hereafter)
   i. Intra-TRP: per TRP Rel. 16/17 Type II codebook components, i.e., SD basis vectors (W1), FD basis vectors (Wf), W2 components (e.g., SCI, indices of NZ coefficients, and amplitude/phase of NZ coefficients).
   ii. Inter-TRP: co-amplitude and co-phase for each TRP.
b. In one example, the new codebook is a joint codebook (called ‘CB2’ hereafter) comprising following components
   i. Per TRP SD basis vectors (W1)
   ii. Single joint FD basis vectors (Wf)
   iii. Single joint W2 components (e.g., SCI, indices of NZ coefficients, and amplitude/phase of NZ coefficients)

In the present disclosure, when the codebook is a legacy codebook (e.g., one of Rel. 15/16/17 NR codebooks, according to one of the examples above), then the CSI reporting is based on a CSI resource set comprising one or multiple NZP CSI-RS resource(s), where each NZP CSI-RS resource comprises CSI-RS antenna ports for all TRPs/RRHs,

$$i . e . , P = {\sum }_{r = 1}^{N} {P}_{r} ,$$

where P is the total number of antenna ports, and Pᵣ is the number of antenna ports associated with r-th TRP. In this case, a TRP corresponds to (or maps to or is associated with) a group of antenna ports.

In the present disclosure, when the codebook is a new codebook (e.g., mTRP/CJT codebook), then the CSI reporting is based on a CSI resource set comprising one or multiple NZP CSI-RS resource(s).
In one example, each NZP CSI-RS resource comprises CSI-RS antenna ports for all TRPs/RRHs.

$$i . e . , P = {\sum }_{r = 1}^{N} {P}_{r} ,$$

P is the total number of antenna ports, and Pᵣ is the number of antenna ports associated with r-th TRP. In this case, a TRP corresponds to (or maps to or is associated with) a group of antenna ports.
In one example, each NZP CSI-RS resource corresponds to (or maps to or is associated with) a TRP/RRH.

In one embodiment, a UE is configured with an mTRP (or D-MIMO) codebook, which is designed based on Rel-16/17 Type-II codebook. The mTRP codebook has a triple-stage structure which can be represented as

$$W = {W}_{1} {W}_{2} {W}_{f}^{H} ,$$

where the component W₁ is used to report/indicate a spatial-domain (SD) basis matrix comprising SD basis vectors, the component W_{f} is used to report/indicate a frequency-domain (FD) basis matrix comprising FD basis vectors, and the component W₂ is used to report/indicate coefficients corresponding to SD and FD basis vectors.

FIG. 16 illustrates an example D-MIMO 1600 where each TRP has a single antenna panel according to embodiments of the present disclosure. The embodiment of the example D-MIMO 1600 where each TRP has a single antenna panel illustrated in FIG. 16 is for illustration only. FIG. 16 does not limit the scope of this disclosure to any particular implementation of the example D-MIMO where each TRP has a single antenna panel.

In one embodiment as illustrated in FIG. 16, each TRP has a single antenna panel. The component W₁ has a block diagonal structure comprising X diagonal blocks, where 1 (co-pol) or 2 (dual-pol) diagonal blocks are associated with each TRP.

In one example, X=N_{TRP} assuming co-polarized (single polarized) antenna structure at each TRP. In one example, when N_{TRP}=2, the components W₁ is given by:

$${W}_{1} = [ \begin{matrix}{B}_{1} & 0 \\ 0 & {B}_{2}\end{matrix} ]$$

where B₁ is a basis matrix for the 1^{st} TRP, and B₂ is a basis matrix for the 2^{nd} TRP. In one example, Bᵣ=[b_{r,0}, b_{r,1}, . . . , b_{r,L}_{ᵣ}₋₁] comprises Lᵣ columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, X=2N_{TRP} assuming dual-polarized (cross-polarized) antenna structure at each TRP.

In one example, when N_{TRP}=2, the components W₁ is given by:

$${W}_{1} = [ \begin{matrix}{B}_{1} & 0 & 0 & 0 \\ 0 & {B}_{1} & 0 & 0 \\ 0 & 0 & {B}_{2} & 0 \\ 0 & 0 & 0 & {B}_{2}\end{matrix} ]$$

where B₁ is a basis matrix for the 1^{st} TRP and is common (the same) for the two polarizations, which correspond to the first and second diagonal blocks, and B₂ is a basis matrix for the 2^{nd} TRP and is common (the same) for the two polarizations, which correspond to the third and fourth diagonal blocks. In general, (2r−1)-th and (2r)-th diagonal blocks correspond to the two antenna polarizations for the r-th TRP. In one example, Bᵣ=[b_{r,0}, b_{r,1}, . . . , b_{r,L}_{ᵣ}₋₁] comprises Lᵣ columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, when N_{TRP}=2, the components W₁ is given by:

$${W}_{1} = [ \begin{matrix}{B}_{1} & 0 & 0 & 0 \\ 0 & {B}_{1} & 0 & 0 \\ 0 & 0 & {B}_{2} & 0 \\ 0 & 0 & 0 & {B}_{2}\end{matrix} ]$$

where B₁ is a basis matrix for the 1^{st} TRP and is common (the same) for the two polarizations, which correspond to the first and third diagonal blocks, and B₂ is a basis matrix for the 2^{nd} TRP and is common (the same) for the two polarizations, which correspond to the second and fourth diagonal blocks. In general, r-th and (r+N_{TRP})-th diagonal blocks correspond to the two antenna polarizations for the r-th TRP. In one example, Bᵣ=[b_{r,0}, b_{r,1}, . . . , b_{r,L}_{ᵣ}₋₁] comprises Lᵣ columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, when N_{TRP}=2, the components W₁ is given by:

$${W}_{1} = [ \begin{matrix}{B}_{1 , 1} & 0 & 0 & 0 \\ 0 & {B}_{1 , 2} & 0 & 0 \\ 0 & 0 & {B}_{2 , 1} & 0 \\ 0 & 0 & 0 & {B}_{2 , 2}\end{matrix} ]$$

where B_{1,1} and B_{1,2} are basis matrices for the first and second antenna polarizations of the 1^{st} TRP, which correspond to the first and second diagonal blocks, and B_{2,1} and B_{2,2} are basis matrices for the first and second antenna polarizations of the 2^{nd} TRP, which correspond to the third and fourth diagonal blocks. In general, (2r−1)-th and (2r)-th diagonal blocks correspond to the two antenna polarizations for the r-th TRP. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th TRP. In one example, L_{r,p}=L for all r and p values (TRP-common and polarization-common L value), for example L∈{2,3,4,6}. In one example, L_{r,p}=Lᵣ for all p values (TRP-specific and polarization-common L value). In one example, L_{r,p}=Lₚ for all r values (TRP-common and polarization-specific L value). In one example, L_{r,p} can be different across TRPs (TRP-specific and polarization-specific L value).

In one example, when N_{TRP}=2, the components W₁ is given by:

$${W}_{1} = [ \begin{matrix}{B}_{1 , 1} & 0 & 0 & 0 \\ 0 & {B}_{1 , 2} & 0 & 0 \\ 0 & 0 & {B}_{2 , 1} & 0 \\ 0 & 0 & 0 & {B}_{2 , 2}\end{matrix} ]$$

where B_{1,1} and B_{1,2} are basis matrices for the first and second antenna polarizations of the 1^{st} TRP, which correspond to the first and third diagonal blocks, and B_{2,1} and B_{2,2} are basis matrices for the first and second antenna polarizations of the 2^{nd} TRP, which correspond to the second and fourth diagonal blocks. In general, r-th and (r+N_{TRP})-th diagonal blocks correspond to the two antenna polarizations for the r-th TRP. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th TRP. In one example, L_{r,p}=L for all r and p values (TRP-common and polarization-common L value), for example L ∈{2,3,4,6}. In one example, L_{r,p}=Lᵣ for all p values (TRP-specific and polarization-common L value). In one example, L_{r,p}=Lₚ for all r values (TRP-common and polarization-specific L value). In one example, L_{r,p} can be different across TRPs (TRP-specific and polarization-specific L value).

In one example,

$$X = {\sum }_{r = 1}^{{N}_{T R P}} {a}_{r} ,$$

where aᵣ=1 for co-polarized (single polarized) antenna structure at r-th TRP, and aᵣ=2 for dual-polarized (cross-polarized) antenna structure at r-th TRP.

In one example, when N_{TRP}=2, the components W₁ is given by:

$${W}_{1} = [ \begin{matrix}{B}_{1} & 0 & 0 \\ 0 & {B}_{2} & 0 \\ 0 & 0 & {B}_{2}\end{matrix} ]$$

where B₁ is a basis matrix for the 1^{st} TRP, and B₂ is a basis matrix for the 2^{nd} TRP and is common (the same) for the two polarizations, which correspond to the second and third diagonal blocks.

In one example, when N_{TRP}=2, the components W₁ is given by:

$${W}_{1} = [ \begin{matrix}{B}_{1} & 0 & 0 \\ 0 & {B}_{2 , 1} & 0 \\ 0 & 0 & {B}_{2 , 2}\end{matrix} ]$$

where B₁ is a basis matrix for the 1^{st} TRP, and B_{2,1} and B_{2,2} are basis matrices for the first and second antenna polarizations of the 2^{nd} TRP, which correspond to the second and third diagonal blocks.

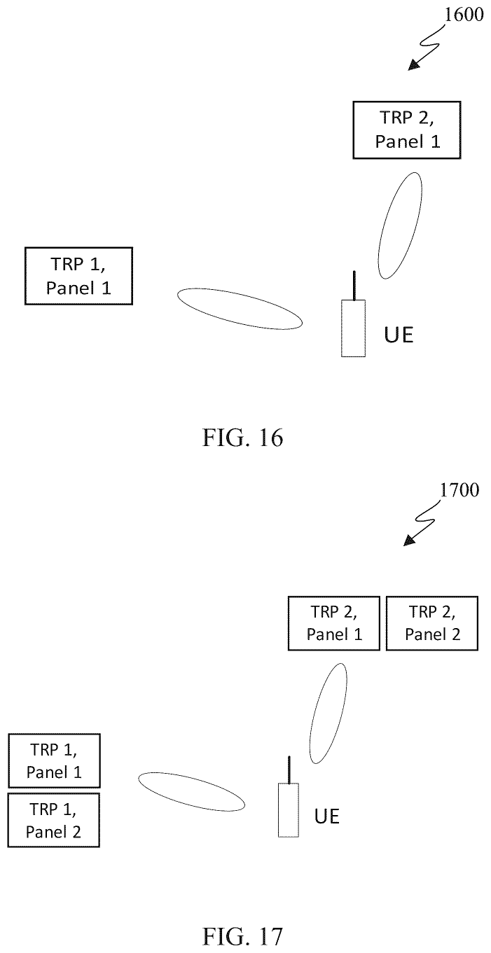

FIG. 17 illustrates an example D-MIMO where each TRP has multiple antenna panels according to embodiments of the present disclosure. The embodiment of the example D-MIMO 1700 where each TRP has a multiple antenna panels illustrated in FIG. 17 is for illustration only. FIG. 17 does not limit the scope of this disclosure to any particular implementation of the example D-MIMO where each TRP has multiple antenna panels.

As illustrated in FIG. 17, in one embodiment, each TRP has multiple antenna panels. The component W₁ has a block diagonal structure comprising X diagonal blocks, where N_{g,r} (co-pol) or 2N_{g,r} (dual-pol) diagonal blocks are associated with r-th TRP comprising N_{g,r} panels and N_{g,r}>1 for all values of r. Note N_{g,r}=2 for both TRPs in FIG. 17.

One or more of the examples described above can be extended in a straightforward manner in this case (of multiple panels at TRPs) by adding the diagonal blocks corresponding to multiple panels in W₁.

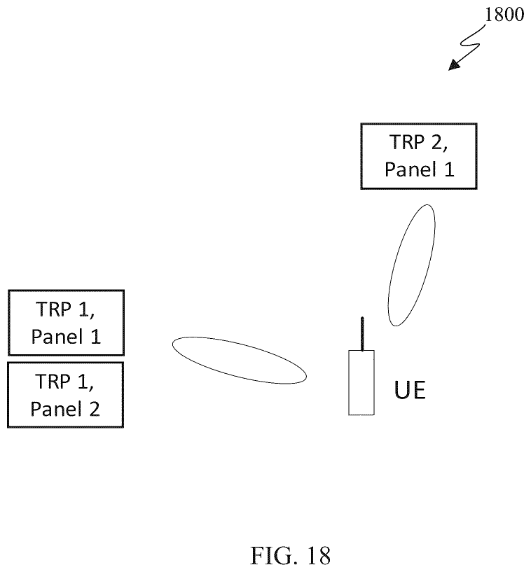

FIG. 18 illustrates an example D-MIMO 1800 where each TRP can be an SP or MP according to embodiments of the present disclosure. The embodiment of the example D-MIMO 1800 where each TRP can be an SP or MP example illustrated in FIG. 18 is for illustration only. FIG. 18 does not limit the scope of this disclosure to any particular implementation of the example D-MIMO where each TRP can be an SP or MP.

As illustrated in FIG. 18, in one embodiment, each TRP can have a single antenna panel or multiple antenna panels (cf. FIG. 11). The component W₁ has a block diagonal structure comprising X diagonal blocks, where N_{g,r} (co-pol) or 2N_{g,r} (dual-pol) diagonal blocks are associated with r-th TRP comprising N_{g,r} panels, and N_{g,r}=1 when r-th TRP has a single panel and N_{g,r}>1 when r-th TRP has multiple panels.

One or more examples described above can be extended in a straightforward manner in this case (of multiple panels at TRPs) by adding the diagonal blocks corresponding to multiple panels in W₁.

In one embodiment, the basis matrices comprising the diagonal blocks of the component W₁ have columns that are selected from a set of oversampled 2D DFT vectors. When the antenna port layout is the same across TRPs, for a given antenna port layout (N₁, N₂) and oversampling factors (O₁, O₂) for two dimensions, a DFT vector v_{l,m} can be expressed as follows.

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}} {u}_{m}}\end{matrix} ]}^{T}$$

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

where l∈{0, 1, . . . , O₁N₁−1} and m∈{0,1, . . . , O₂N₂−1}.

When the antenna port layout can be different across TRPs, for a given antenna port layout (N_{1,r}, N_{2,r}) and oversampling factors (O_{1,r}, O_{2,r}) associated with r-th TRP, a DFT vector vₗ_{ᵣ}_{,m}_{ᵣ}, my can be expressed as follows.

$${v}_{{l}_{r} , {m}_{r}} = {[ \begin{matrix}{u}_{{m}_{r}} & {e}^{j \frac{2 π {l}_{r}}{{O}_{1 , r} {N}_{1 , r}}} {u}_{{m}_{r}} & … & {e}^{j \frac{2 π {l}_{r} ( {N}_{1 , r} - 1 )}{{O}_{1 , r} {N}_{1 , r}} {u}_{{m}_{r}}}\end{matrix} ]}^{T}$$

$${u}_{{m}_{r}} = [ \begin{matrix}1 & {e}^{j \frac{2 π {m}_{r}}{{O}_{2 , r} {N}_{2 , r}}} & … & {e}^{j \frac{2 π {m}_{r} ( {N}_{2 , r} - 1 )}{{O}_{2 , r} {N}_{2 , r}}}\end{matrix} ]$$

where lᵣ∈{0,1, . . . , O_{1,r}N_{1,r}−1} and mᵣ∈{0, 1, . . . , O_{2,r}N_{2,r}−1}.

In one example, the oversampling factor is TRP-common, hence remains the same across TRPs. For example, e.g., O_{1,4}=O₁=O_{2,r}=O₂=4. In one example, the oversampling factor is TRP-specific, hence is independent for each TRP. For example, O_{1,r}=O_{2,r}=x and x is chosen (fixed or configured) from {2,4,8}.

In one embodiment, the basis matrices comprising the diagonal blocks of the component W₁ have columns that are selected from a set of port selection vectors. When the antenna port layout is the same across TRPs, for a given number of CSI-RS port P_{CSI-RS}, a port selection vector vₘ is a P_{CSI-RS}/2-element column vector containing a value of 1 in element

$$( m mod \frac{{P}_{CSI - RS}}{2} )$$

and zeros elsewhere (where the first element is element 0).

When the antenna port layout can be different across TRPs, for a given number of CSI-RS port P_{CSI-RS,r}, a port selection vector vₘ_{ᵣ} is a P_{CSI-RS,r}/2-element column vector containing a value of 1 in element

$$( {m}_{r} mod \frac{{P}_{CSI - RS , r}}{2} )$$

and zeros elsewhere (where the first element is element 0).

In one embodiment, each TRP can have a single antenna panel or multiple antenna panels (cf. FIG. 9). The component W₁ has a block diagonal structure comprising X=2 diagonal blocks, where N_{g,r} (co-pol) or 2N_{g,r} (dual-pol) diagonal blocks are associated with r-th TRP comprising N_{g,r} panels, and N_{g,r}=1 when r-th TRP has a single panel and N_{g,r}>1 when r-th TRP has multiple panels.

In one embodiment, the component W_{f} is according to at least one of the following examples.

In one example, the component W_{f} is TRP-common and layer-common, i.e., one common W_{f} is reported for all TRPs and for all layers (when number of layers or rank >1).

In one example, the component We is TRP-common and layer-specific, i.e., for each layer l∈{1, . . . , v}, where v is a rank value or number of layers, one common We is reported for all TRPs.

In one example, the component W_{f} is TRP-specific and layer-common, i.e., for each TRP r∈{1, . . . , N_{TRP}}, one common W_{f} is reported for all layers.

In one example, the component W_{f} is TRP-specific and layer-specific, i.e., for each TRP r∈{1, . . . , N_{TRP}} and for each layer l∈{1, . . . , v}, one W_{f} is reported.

In one embodiment, let W_{f} comprise Mᵥ columns for a given rank value v. The value of Mᵥ can be fixed (e.g., ½). or configured via higher layer (RRC) signaling (similar to R16 enhanced Type II codebook) or reported by the UE as part of the CSI report). The value of Mᵥ is according to at least one of the following examples.

In one example, the value of Mᵥ is TRP-common, layer-common, and RI-common. The same Mᵥ value is used common for all values of N_{TRP}, v, and layers=1, . . . , v.

In one example, the value of Mᵥ is TRP-common, layer-common, and RI-specific. For each RI value v, the same Mᵥ value is used common for all values of N_{TRP} and layers=1, . . . , v.

In one example, the value of Mᵥ is TRP-common, layer-specific, and RI-common. For each layers=1, . . . , v, the same Mᵥ value is used common for all values of N_{TRP} and v.

In one example, the value of Mᵥ is TRP-specific, layer-common, and RI-common. For each TRP r∈{1, . . . , N_{TRP}}, the same Mᵥ value is used common for all values of v and layers=1, . . . , v.

In one example, the value of Mᵥ is TRP-common, layer-specific, and RI-specific.

In one example, the value of Mᵥ is TRP-specific, layer-specific, and RI-common. In one example, the value of Mᵥ is TRP-specific, layer-common, and RI-specific.

In one example, the value of Mᵥ is TRP-specific, layer-specific, and RI-specific.

In one embodiment, the columns of W_{f} are selected from a set of oversampled DFT vectors. When the antenna port layout is the same across TRPs, for a given N₃ and oversampling factors O₃, a DFT vector y_{f} can be expressed as follows.

$${y}_{f} = [ \begin{matrix}1 & {e}^{j \frac{2 π f}{{O}_{3} {N}_{3}}} & … & {e}^{j \frac{2 π f ( {N}_{3} - 1 )}{{O}_{3} {N}_{3}}}\end{matrix} ]$$

where f∈{0,1, . . . , O₃N₃−1}.

When N₃ value can be different across TRPs, for r-th TRP, a DFT vector y_{f}_{ᵣ} can be expressed as follows.

$${y}_{{f}_{r}} = [ \begin{matrix}1 & {e}^{j \frac{2 π {f}_{r}}{{O}_{3 , r} {N}_{3 , r}}} & … & {e}^{j \frac{2 π {f}_{r} ( {N}_{3} - 1 )}{{O}_{3 , r} {N}_{3 , r}}}\end{matrix} ]$$

where fᵣ∈{0,1, . . . , O_{3,r}N_{3,r}−1}.

In one example, the oversampling factor is TRP-common, hence remains the same across TRPs. For example, e.g., O_{3,r}=O₃. In one example, the oversampling factor is TRP-specific, hence is independent for each TRP. For example, O_{3,r}=x and x is chosen (fixed or configured) from {1,2,4,8}. In one example, the oversampling factor=1. Then, the DFT vector y_{f} can be expressed as follows.

$${y}_{f} = [ \begin{matrix}1 & {e}^{j \frac{2 π f}{{N}_{3}}} & … & {e}^{j \frac{2 π f ( {N}_{3} - 1 )}{{N}_{3}}}\end{matrix} ] .$$

In one embodiment, the columns of W_{f} are selected from a set of port selection vectors. When N₃ value is the same across TRPs, for a given N₃ value, a port selection vector vₘ is a N₃-element column vector containing a value of 1 in element (m mod N₃) and zeros elsewhere (where the first element is element 0).

When N₃ value can be different across TRPs, for a given N_{3,r} value, a port selection vector vₘ_{ᵣ} is a N₃-element column vector containing a value of 1 in element (mᵣ mod N₃) and zeros elsewhere (where the first element is element 0).

In one embodiment, a maximum value of the (i.e., an upper bound on) number of non-zero coefficients in component W₂ is common for TRPs (i.e., TRP-common upper bound). In one example, a ratio β of a maximum value of the non-zero coefficients (K₀) to a total number (K) of elements in component W₂ is common for TRPs, i.e., β=K₀/K is a same for all TRPs. In one example, K₀=┌βK┐. In one example, the value of β can be fixed or configured via higher-layer parameter, MAC-CE, or DCI. In one example,

$$β ∈ \{ \frac{1}{2} , \frac{2}{3} , \frac{3}{4} , 1 \} .$$

In another example,

$$β ∈ \{ \frac{1}{2} , \frac{3}{4} , 1 \} .$$

In one example, the value of β is layer-common, i.e., it is the same for all layers. In another example, the value of β is layer-specific. In one example the value of β is layer-pair-specific, and it can be different for different layer pairs (l, l+1), e.g., similar to β in Rel-16 codebook)

In one example, β and other parameter(s) are jointly indicated by a parameter (e.g., an RRC parameter). For example, a parameter to jointly indicate β, L and/or Mᵥ (as in Rel. 16 codebook) or jointly indicate M, α, β (as in Rel. 17 codebook) can be used.

In one embodiment,

$$β = \frac{{K}_{0 , tot}}{{K}_{tot}} ,$$

a ratio of a maximum value of (i.e., an upper bound on) the number of non-zero coefficients (K_{0,tot}) across TRPs to the total number of non-zero coefficients (Kₜₒₜ) across TRPs is fixed or configured via higher-layer parameter, MAC-CE, or DCI. In this case, since β for each TRP is not restricted, any number of non-zero coefficients for each TRP can be allocated under the constraint that K_{0,tot}=┌βKₜₒₜ┐. In one example,

$$β ∈ \{ \frac{1}{2} , \frac{2}{3} , \frac{3}{4} , 1 \} .$$

In another example,

$$β ∈ \{ \frac{1}{2} , \frac{3}{4} , 1 \} .$$

In one example, the value of β is layer-common, i.e., it is the same for all layers. In another example, the value of β is layer-specific. In one example the value of β is layer-pair-specific, and it can be different for different layer pairs (l, l+1), e.g., similar to β in Rel-16 codebook)

In one example, β and other parameter(s) are jointly indicated by a parameter (e.g., an RRC parameter). For example, a parameter to jointly indicate β, L and/or Mᵥ (as in Rel. 16 codebook) or jointly indicate M, α, β (as in Rel. 17 codebook) can be used.

In one example, a ratio of a maximum value of (i.e., an upper bound on) the number of non-zero coefficients (K₀) for a TRP (per TRP) to the total number of non-zero coefficients (Kₜₒₜ) across TRPs is β×s, where s is a scaling factor. In one example, the scaling factor is fixed, e.g.,

$$s = \frac{1}{{N}_{TRP}} .$$

In another example, s is configured via higher-layer parameter, MAC-CE, or DCI. In another example, s can be TRP-specifically configured/fixed.

In one embodiment, βₗ and βₜₒₜ can be fixed or configured via higher-layer parameter, MAC-CE, or DCI, where βₗ is per TRP restriction as described above, and βₜₒₜ is for all TRP restriction as described above:
In one example, βₗ is configured and βₜₒₜ is determined based on βₗ, e.g., K_{0,tot}=2βₗK or aβₗK in general, where a can be fixed, configured, or reported. For example, a is fixed to N_{TRP}
In one example, βₜₒₜ is configured, and βₗ is determined based on βₜₒₜ.
In one example, both of βₗ and βₜₒₜ are configured via higher-layer parameter, MAC-CE, or DCI.
In one example, both of βₗ and βₜₒₜ are fixed.
In one example, one of them is reported by the UE, and the other is fixed/configured.

In one example, for rank in S₁, βₗ and/or βₜₒₜ are designed based on the above, and for rank in S₂, βₗ and/or βₜₒₜ are designed based on a further restriction of the above.
In one example, S₁={1,2} and S₂={3,4}.
For rank in S₂, Bₗ and βₜₒₜ can be designed in a manner that combines the approach for rank 3-4 design from Rel. 16 codebook with the above design principle. For example, K_{0,tot}=2βₗK for rank in S₂

In one example, when N_{TRP}≤x, βₗ and/or βₜₒₜ is a first value (or pair), and when N_{TRP}>x, βₗ and/or βₜₒₜ is a second value (or pair), where x is a threshold value, which can be fixed e.g., 2 or configured. In one example, (the first value, the second value) or (the first pair or the second pair) are configured or fixed.

For example, if x is fixed to 2, βₗ is configured or fixed, and
βₜₒₜ=aβₗK when N_{TRP}=2. In one example, a=2 or can be configured or reported.
βₜₒₜ=bβₗK when N_{TRP}=3 or 4. In one example, b=3 or can be configured or reported.

In one example, βₗ and/or βₜₒₜ is N_{TRP}-specific, rank-specific, and layer-specific.

In one example, βₗ and/or βₜₒₜ is N_{TRP}-specific, rank-specific, and layer-common.

In one example, βₗ and/or βₜₒₜ is N_{TRP}-specific, rank-common, and layer-specific.

In one example, βₗ and/or βₜₒₜ is N_{TRP}-specific, rank-common, and layer-common.

In one example, βₗ and/or βₜₒₜ is N_{TRP}-common, rank-specific, and layer-specific.

In one example, βₗ and/or βₜₒₜ is N_{TRP}-common, rank-specific, and layer-common.

In one example, βₗ and/or βₜₒₜ is N_{TRP}-common, rank-common, and layer-specific.

In one example, βₗ and/or βₜₒₜ is N_{TRP}-common, rank-common, and layer-common.

In one embodiment, a maximum value of the (i.e., an upper bound on) number of non-zero coefficients in component W₂ is TRP-specific (i.e., one separate value for each TRP). In one example, a ratio β of a maximum value of the non-zero coefficients to a total number of elements in component W₂ is TRP-specific, i.e., the value of β is independent for each TRP.

In one example, when N_{TRP}=4, the component W₂ can be expressed as

$${W}_{2} = [ \begin{matrix}{W}_{2 , 1} \\ {W}_{2 , 2} \\ {W}_{2 , 3} \\ {W}_{2 , 4}\end{matrix} ] ,$$

where W_{2,r} is a coefficient matrix for TRP r, and the value of βᵣ is a ratio of a maximum value of (i.e., an upper bound on) the number of non-zero coefficients (K_{0,r}) to a total number (Kᵣ) of elements of in W_{2,r}, i.e., βᵣ=K_{0,r}/Kᵣ is TRP-specific. In one example, K_{0,r}=┌βᵣ Kᵣ┐.

In one example, for each TRP r={1, . . . , N_{TRP}}, βᵣ is configured via higher-layer parameter, MAC-CE, or DCI. In one example,

$${β}_{r} ∈ \{ \frac{1}{2} , \frac{2}{3} , \frac{3}{4} , 1 \} .$$

In another example,

$${β}_{r} ∈ \{ \frac{1}{2} , \frac{3}{4} , 1 \} .$$

In one example, the value of βᵣ is layer-common, i.e., it is the same for all layers. In another example, the value of βᵣ is layer-specific. In another example, βᵣ can be fixed.

In one example, some rules on choosing/indicating {βᵣ} are pre-defined. For example, β₁≥β₂≥ . . . ≥β_{N}_{_{TRP}} where βᵣ is a ratio of non-zero coefficients for the r-th strongest TRP.

In one example, when N_{TRP}=2,

$$( {β}_{1} , {β}_{2} ) = ( 1 , \frac{3}{4} ) ,$$

i.e., β₁=1 for the stronger TRP and

$${β}_{1} = \frac{3}{4}$$

for the weaker TRP.

In another example, when

$${N}_{TRP} = 4 , ( {β}_{1} , {β}_{2} , {β}_{3} , {β}_{4} ) = ( 1 , \frac{3}{4} , \frac{2}{3} , \frac{1}{2} ) .$$

In one example, βᵣ is configured via higher-layer parameter, MAC-CE, or DCI. In one example,

$${β}_{r} ∈ \{ \frac{1}{2} , \frac{2}{3} , \frac{3}{4} , 1 \}$$

for r-th strongest TRP for r=1, . . . , N_{TRP}. In another example,

$${β}_{r} ∈ \{ \frac{1}{2} , \frac{3}{4} , 1 \}$$

for r-th strongest TRP for r=1, . . . , N_{TRP}.

In one example, βᵣ can be configured for each TRP r.

In one example, βᵣ can be configured for each TRP pair (r, r+1), i.e., one value for TRP pair (1,2) and another value TRP pair (3,4). For example, when N_{TRP}=4, β₁₂=β₁=β₂=1 and

$${β}_{34} = {β}_{3} = {β}_{4} = \frac{3}{4} .$$

Here, β₁₂ and β₃₄ are configured or fixed or reported by UE.

In another example, {βᵣ} are jointly indicated by a parameter. For example, in the case of 2 TRPs, a parameter to indicate (β₁, β₂) pair can be designed, as shown in the following table.

| index | (β₁, β₂) |
|---|---|
| 0 | (1, 1) |
| 1 | (1, ¾) |
| 2 | (1, ⅔) |
| 3 | (¾, ¾) |
| 4 | (¾, ⅔) |
| 5 | (¾, ½) |
| 6 | (⅔, ⅔) |
| 7 | (⅔, ½) |

In one example, {βᵣ} are jointly indicated by a parameter for some case, but are independently indicated by multiple parameters each for βᵣ. For example, {βᵣ} are jointly indicated by a parameter for the case of 2 TRPs (i.e., N_{TRP}=2), and are independent indicated for the cases of 3 and 4 TRPs (i.e., N_{TRP}=3, 4).

In another example, {βᵣ} and other parameter(s) are jointly indicated by a parameter (i.e., a parameter indicating combinations of multiple parameters). For example, a parameter to indicate {βᵣ}, L, and/or Mᵥ (similar to Rel-16 codebook) jointly can be used. In another example, a parameter to indicate {βᵣ}, α, and/or Mᵥ (similar to Rel. 17 codebook).

In another example, βᵣ=βa^{r-1}, where a≤1 is a scaling factor. For example, a can be fixed (e.g., ½) or configured via higher-layer parameter, MAC-CE, or DCI. In one example,

$$a ∈ \{ \frac{3}{4} , \frac{4}{5} \} .$$

In another example,

$$a ∈ \{ \frac{3}{4} , 1 \} .$$

In this case, β and a are configured to the UE. In one example, a is reported by the UE, as part of the CSI report. Such a reporting can be via a UCI parameter (new or existing) in UCI part 1 of a two-part UCI to report CSI.

In another example, when βᵣ is configured for each TRP pair (r,r+1), i.e., one value for TRP pair (1,2) and another value TRP pair (3,4), the values of β₁₂ and β₃₄ can be jointly indicated by a parameter (for the case of 4 TRPs), where β₁₂=β₁=β₂ and β₃₄=β₃=β₄. For example, a parameter to indicate (β₁₂, β₃₄) pair can be designed, as shown in the following table.

| index | (β₁₂, β₃₄) |
|---|---|
| 0 | (1, 1) |
| 1 | (1, ¾) |
| 2 | (1, ⅔) |
| 3 | (¾, ¾) |
| 4 | (¾, ⅔) |
| 5 | (¾, ½) |
| 6 | (⅔, ⅔) |
| 7 | (⅔, ½) |

In one example, {β_{r,r+1}} are jointly indicated by a parameter for some case, but are independently indicated by multiple parameters each for βᵣ. For example, {β_{r,r+1}} are jointly indicated by a parameter for the case of 4 TRPs (i.e., N_{TRP}=4).

In another example, {β_{r,r+1}} and other parameter(s) are jointly indicated by a parameter (i.e., a parameter indicating combinations of multiple parameters). For example, a parameter to indicate {β_{r,r+1}}, L, and/or Mᵥ (similar to Rel-16 codebook) jointly can be used. In another example, a parameter to indicate {β_{r,r+1}}, α, and/or Mᵥ (similar to Rel. 17 codebook).

In another example, β_{2r-1,2r}=βa^{r-1}, where a≤1 is a scaling factor. For example, a can be fixed (e.g., ½) or configured via higher-layer parameter, MAC-CE, or DCI. In one example,

$$a ∈ \{ \frac{3}{4} , \frac{4}{5} \} .$$

In another example,

$$a ∈ \{ \frac{3}{4} , 1 \} .$$

In this case, β and a are configured to the UE. In one example, a is reported by the UE, as part of the CSI report. Such a reporting can be via a UCI parameter (new or existing) in UCI part 1 of a two-part UCI to report CSI.

In one example, the UE reports information on the order of strongest TRPs (or weakest TRPs) for NW to identify which TRP corresponds to r-th strongest TRP. In this case, an indicator with ┌log₂ N_{TRP}!┐ is used to indicate/report the order of strongest TRPs in CSI reporting.

In one example, the UE does not report information on the order of strongest TRPs (or weakest TRPs) and the UE reports non-zero coefficients for each TRP in the order of original TRP index r, when {βᵣ} are different across TRPs. In this case, the NW can identify which TRP corresponds to r-th strongest TRP by counting the number of non-zero coefficients in W₂ or based on the sum power of the non-zero coefficients for each TRP or other implementation methods.

In one example, the value of βᵣ is layer-common, i.e., it is the same for all layers.

In one example, the value of βᵣ is layer-specific, and it can be different for different layer.

In one example, the value of βᵣ is layer-pair-specific, and it can be different for different layer pairs (l, l+1), e.g., similar to β in Rel-16 codebook)

In one example, βᵣ is layer-common for Type-II port selection-based codebook extension for multi-TRPs (similar to Rel7), and is layer-specific or layer-pair-specific for regular Type-II (similar to Rel-16).

In one embodiment, a bitmap (or multiple bitmaps) is used to indicate the location (or index) of the non-zero coefficients of the component W₂. In one example, this bitmap is common for all layers, i.e., one bitmap is reported for all layers. In another example, this bitmap is layer-specific, i.e., one bitmap is reported for each layer value.

In one example, a bitmap is used to indicate the location (or index) of the non-zero coefficients corresponding to each of the N_{TRP} TRPs (bit-map partitioning). In this case, N_{TRP} bitmaps are defined.

In one embodiment, a strongest coefficient indicator (SCI) is used to indicate the location (or index) of the strongest coefficient of the component W₂. In one example, the SCI is common for all layers, i.e., one SCI is reported for all layers. In another example, the SCI is layer-specific, i.e., one SCI is reported for each layer value.

In one example, a SCI is used for each TRP (i.e., TRP-specific). For example, the location (or index) of the strongest coefficient for each TRP is defined based on a number of coefficients for the associated TRP (e.g., for the case that a bitmap is defined for each TRP in such case of one or more examples described above).

In another example, N_{TRP} locations (or indices) corresponding to the strongest coefficients for N_{TRP} TRPs are defined based on the whole (total) number of coefficients for the N_{TRP} TRPs.

In one example, a SCI for each TRP indicates a SD beam index for a strongest coefficient and the FD beam index corresponding to the strongest coefficient is fixed to 0 (similar to Rel-16 Type-II codebook).

In one example, a SCI for each TRP indicates SD and FD beam indices for a strongest coefficient (similar to Rel-17 Type-II codebook).

In one embodiment, amplitude and phase of the non-zero coefficients of the component W₂ are reported using respective codebooks. In one example, the phase codebook is fixed, e.g., 16 PSK. In one example, the phase codebook with nₚ-bit is configured, e.g., from 8 PSK (nₚ=3-bit per phase) and 16 PSK (nₚ=4-bit per phase). In one example, an nₐ-bit amplitude codebook comprising equidistance points in [0,1] in dB-scale (or log, or linear-scale) is used (similar to Rel-15/16/17 codebooks for amplitudes). In one example, the amplitude codebook can be fixed or configured via higher-layer parameter, MAC-CE, or DCI.

In one example, the amplitude codebook is TRP-common, i.e., a same amplitude codebook is used for coefficients associated with all TRPs.

In one example, for reference amplitude values, i.e., on p⁽¹⁾, a lower-bit (say nₐ bit) amplitude codebook (compared to Rel-16 codebook for amplitude) is configured/fixed when N_{TRP}>α or N>α where N is the number of cooperating TRPs N≤N_{TRP}. (N can be configured via RRC, MAC-CE, or DCI or determined by UE and reported).
In one example, α is fixed e.g., α=1, 2, or 3. In another example, a is configured via RRC, MAC-CE, or DCI, e.g., α∈{1,2,3}.
In one example, nₐ=3, 2 or 1 (fixed) when N_{TRP}>α or N>α.
In one example, nₐ ∈{1,2,3} is configured via RRC, MAC-CE, or DCI when N_{TRP}>α or N>α.
In one example, nₐ ∈{1,2,3} is determined by the UE and reported.

In one example, for differential amplitude values, i.e., on p⁽²⁾, a lower-bit (say nₐ bit) amplitude codebook (compared to Rel-16 codebook for amplitude) is configured/fixed when N_{TRP}>α or N>α where N is the number of cooperating TRPs N≤N_{TRP}. (N can be configured via RRC, MAC-CE, or DCI or determined by UE and reported).
In one example, α is fixed e.g., a=1, 2, or 3. In another example, α is configured via RRC, MAC-CE, or DCI, e.g., α∈{1,2,3}.
In one example, nₐ=2 or 1 (fixed) when N_{TRP}>α or N>α.
In one example, nₐ∈{1,2} is configured via RRC, MAC-CE, or DCI when N_{TRP}>α or N>α.
In one example, nₐ∈{1,2} is determined by the UE and reported.

In one example, for both reference and differential amplitude values, lower-bit (say n_{a,ref}, n_{a,diff} bits) amplitude codebooks (compared to Rel-16 codebook for amplitude) are configured/fixed when N_{TRP}>α or N>α where N is the number of cooperating TRPs N≤N_{TRP}. (N can be configured via RRC, MAC-CE, or DCI or determined by UE and reported).

In one example, the amplitude codebook is TRP-specific, i.e., a different amplitude codebook can be used for coefficients associated with each TRP.

In one example, for reference amplitude values, i.e., on p⁽¹⁾, an n_{a,r}-bit amplitude codebook is configured to use for r-th strongest TRP. In one example, n_{a,r}∈{3,4} or n_{a,r}∈{2,3,4} and one of the values is configured to the UE for each r. In one example, n_{a,1}≥n_{a,2}≥ . . . ≥n_{a,N}_{_{TRP}} or n_{a,1}≥n_{a,2}≥ . . . ≥n_{a,N} (N≤N_{TRP}) can be configured to the UE and n_{a,r} is for the r-th strongest TRP.

In one example, for differential amplitude values, i.e., on p⁽²⁾, an n_{a,r}-bit amplitude codebook is configured to use for r-th strongest TRP. In one example, n_{a,r}∈{2,3} or n_{a,r}∈{1,2,3} and one of the values is configured to the UE for each r. In one example, n_{a,1}≥n_{a,2}≥ . . . ≥n_{a,N}_{_{TRP}} or n_{a,1}≥n_{a,2}≥ . . . ≥n_{a,N} (N≤N_{TRP}) can be configured to the UE and n_{a,r} is for the r-th strongest TRP.

In one embodiment, for reference amplitude values, i.e., on p⁽¹⁾, two amplitude codebooks (with n_{a,1} and n_{a,2} bits) for non-zero coefficients in two groups G1 and G2, respectively, are used when N_{TRP}>α or N>α.
In one example, G1 and G2 are configured by NW via RRC, MAC-CE, or DCI.
In one example, G1 and G2 are determined by UE and reported.
In one example, G1 and G2 are determined implicitly. For example, G1 includes the strongest TRP and G2 includes the other TRPs)·
In one example, α is fixed e.g., a=1, 2, or 3. In another example, α is configured via RRC, MAC-CE, or DCI, e.g., α∈{1,2,3}.
n_{a,1} and n_{a,2} are fixed or configured or determined by UE and reported.
In one example, n_{a,1}≥n_{a,2}, where n_{a,1} ∈{3,4} and n_{a,2} ∈{2,3}.

In one embodiment, for differential amplitude values, i.e., on p⁽²⁾, two amplitude codebooks (with n_{a,1} and n_{a,2} bits) for non-zero coefficients in two groups G1 and G2, respectively, are used when N_{TRP}>α or N>α.
In one example, G1 and G2 are configured by NW via RRC, MAC-CE, or DCI.
In one example, G1 and G2 are determined by UE and reported.
In one example, G1 and G2 are determined implicitly. For example, G1 includes the strongest TRP and G2 includes the other TRPs)·
In one example, α is fixed e.g., α=1, 2, or 3. In another example, α is configured via RRC, MAC-CE, or DCI, e.g., α∈{1,2,3}.
n_{a,1} and n_{a,2} are fixed or configured or determined by UE and reported.
In one example, n_{a,1}≥n_{a,2}, where n_{a,1} ∈{2,3} and n_{a,2} ∈{1,2}.

In one embodiment, for reference amplitude values, i.e., on p⁽¹⁾, two amplitude codebooks (with n_{a,1} and n_{a,2} bits) for non-zero coefficients in two groups G1 and G2, respectively, are used regardless of the value of N_{TRP} or N.
In one example, G1 includes 1 TRP, and G2 includes N_{TRP}−1 or N−1 TRPs.
In one example, G1 includes └N_{TRP}/2┘ or └N/2┘ TRP, and G2 includes ┌N_{TRP}/2┐ or ┌N/2┐ TRPs.
In one example, G1 includes ┌N_{TRP}/2┐ or ┌N/2┐ TRP, and G2 includes └N_{TRP}/2┘ or └N/2┘ TRPs.
In one example, G1 includes one TRP, and G2 includes one TRP for the case when N_{TRP}=2 or when the number of co-operating TRPs N=2, where N≤N_{TRP}.
In one example, G1 includes one TRP, and G2 includes two TRPs for the case when N_{TRP}=3 or when the number of co-operating TRPs N=3, where N≤N_{TRP}.
In one example, G1 includes one TRP, and G2 includes three TRPs for the case when N_{TRP}=4 or when the number of co-operating TRPs N=4, where N≤N_{TRP}.
In one example, G1 includes two TRPs, and G2 includes one TRP for the case of N_{TRP}=3 or when the number of co-operating TRPs N=3, where N≤N_{TRP}.
In one example, G1 includes two TRPs, and G2 includes two TRPs for the case of N_{TRP}=4 or when the number of co-operating TRPs N=4, where N≤N_{TRP}.
In one example, G1 includes three TRPs, and G2 includes one TRP for the case of N_{TRP}=4 or when the number of co-operating TRPs N=4, where N≤N_{TRP}.
n_{a,1} and n_{a,2} are fixed or configured or determined by UE and reported.
In one example, n_{a,1}≥n_{1,2}, wherein n_{a,1}∈{3,4} and n_{a,2}∈{2,3}.

In one embodiment, for differential amplitude values, i.e., on p⁽²⁾, two amplitude codebooks (with n_{a,1} and n_{a,2} bits) for non-zero coefficients in two groups G1 and G2, respectively, are used regardless of the value of N_{TRP} or N.
In one example, G1 includes 1 TRP, and G2 includes N_{TRP}−1 or N−1 TRPs.
In one example, G1 includes └N_{TRP}/2┘ or └N/2┘ TRP, and G2 includes ┌N_{TRP}/2┐ or ┌N/2┐ TRPs.
In one example, G1 includes ┌N_{TRP}/2┐ or ┌N/2┐ TRP, and G2 includes └N_{TRP}/2┘ or └N/2┘ TRPs.
In one example, G1 includes one TRP, and G2 includes one TRP for the case when N_{TRP}=2 or when the number of co-operating TRPs N=2, where N≤N_{TRP}.
In one example, G1 includes one TRP, and G2 includes two TRPs for the case when N_{TRP}=3 or when the number of co-operating TRPs N=3, where N≤N_{TRP}.
In one example, G1 includes one TRP, and G2 includes three TRPs for the case when N_{TRP}=4 or when the number of co-operating TRPs N=4, where N≤N_{TRP}.
In one example, G1 includes two TRPs, and G2 includes one TRP for the case of N_{TRP}=3 or when the number of co-operating TRPs N=3, where N≤N_{TRP}.
In one example, G1 includes two TRPs, and G2 includes two TRPs for the case of N_{TRP}=4 or when the number of co-operating TRPs N=4, where N≤N_{TRP}.
In one example, G1 includes three TRPs, and G2 includes one TRP for the case of N_{TRP}=4 or when the number of co-operating TRPs N=4, where N≤N_{TRP}.
n_{a,1} and n_{a,2} are fixed or configured or determined by UE and reported.
In one example, n_{a,1}≥n_{1,2}, wherein n_{a,1}∈{3,4} and n_{a,2}∈{2,3}.

In one example, the phase codebook is TRP-common, i.e., a same phase codebook is used for coefficients associated with all TRPs.

In one example, a lower-bit (say nₚ bits) phase codebook (compared to Rel-16 codebook for phase) is configured/fixed when N_{TRP}>α or N>α where N is the number of cooperating TRPs N≤N_{TRP}. (N can be configured via RRC, MAC-CE, or DCI or determined by UE and reported).
In one example, α is fixed e.g., α=1, 2, or 3. In another example, α is configured via RRC, MAC-CE, or DCI, e.g., α∈{1,2,3}.
In one example, nₚ=2 or 1 (fixed) when N_{TRP}>α or N>α.
In one example, nₚ∈{1,2} is configured via RRC, MAC-CE, or DCI when N_{TRP}>α or N>α.
In one example, nₚ∈{1,2} is determined by the UE and reported.

In one example, the phase codebook is TRP-specific, i.e., a different phase codebook can be used for coefficients associated with each TRP. In one example, an n_{p,r}-bit phase codebook is configured to use for r-th strongest TRP. In one example, n_{p,r}∈{3,4} or n_{p,r} ∈{2,3,4} and one of the value is configured to the UE for each r. In one example, n_{p,1}≥n_{p,2}≥ . . . ≥n_{p,N}_{_{TRP}} can be configured to the UE and n_{p,r} is for the r-th strongest TRP.

In one embodiment, two phase codebooks (with n_{p,1}, n_{p,2} bits) for non-zero coefficients in two groups G1 and G2, respectively, are used when N_{TRP}>α or N>α.
In one example, G1 and G2 are configured by NW via RRC, MAC-CE, or DCI.
In one example, G1 and G2 are determined by UE and reported.
In one example, G1 and G2 are determined implicitly. For example, G1 includes the strongest TRP and G2 includes the other TRPs)
In one example, α is fixed e.g., α=1, 2, or 3. In another example, α is configured via RRC, MAC-CE, or DCI, e.g., α∈{1,2,3}.
n_{p,1} and n_{p,2} are fixed or configured or determined by UE and reported.
In one example, n_{a,1}≥n_{a,2}, where n_{a,1} ∈{3,4} and n_{a,2} ∈{1,2}.

In one embodiment, two phase codebooks (with n_{p,1}, n_{p,2} bits) for non-zero coefficients in two groups G1 and G2, respectively, are used regardless of the value of N_{TRP} or N.
In one example, G1 includes 1 TRP, and G2 includes N_{TRP}−1 or N−1 TRPs.
In one example, G1 includes └N_{TRP}/2┘ or └N/2┘ TRP, and G2 includes ┌N_{TRP}/2┐ or ┌N/2┐ TRPs.
In one example, G1 includes ┌N_{TRP}/2┐ or ┌N/2┐ TRP, and G2 includes └N_{TRP}/2┘ or └N/2┘ TRPs.
In one example, G1 includes one TRP, and G2 includes one TRP for the case when N_{TRP}=2 or when the number of co-operating TRPs N=2, where N≤N_{TRP}
In one example, G1 includes one TRP, and G2 includes two TRPs for the case when N_{TRP}=3 or when the number of co-operating TRPs N=3, where N≤N_{TRP}.
In one example, G1 includes one TRP, and G2 includes three TRPs for the case when N_{TRP}=4 or when the number of co-operating TRPs N=4, where N≤N_{TRP}.
In one example, G1 includes two TRPs, and G2 includes one TRP for the case of N_{TRP}=3 or when the number of co-operating TRPs N=3, where N≤N_{TRP}.
In one example, G1 includes two TRPs, and G2 includes two TRPs for the case of N_{TRP}=4 or when the number of co-operating TRPs N=4, where N≤N_{TRP}.
In one example, G1 includes three TRPs, and G2 includes one TRP for the case of N_{TRP}=4 or when the number of co-operating TRPs N=4, where N≤N_{TRP}.
n_{p,1} and n_{p,2} are fixed or configured or determined by UE and reported.
In one example, n_{p,1}≥n_{p,2}, where n_{a,1} ∈{3,4} and n_{a,2} ∈{1,2}.

In one embodiment, the codebook includes additional components due to N_{TRP}>1 TRPs.

In one example, the additional components include inter-TRP phase. In one example, the inter-TRP phase values correspond to N_{TRP}−1 phase values (e.g., assuming one of the TRPs is a reference and has a fixed phase value=1). In another example, the inter-TRP phase values correspond to N_{TRP} phase values. The inter-TRP phase values can be quantized/reported as scalars using a scalar codebook (e.g., QPSK, 2 bits per phase or 8 PSK, 3 bits per phase) or as a vector using a vector codebook (e.g., a DFT codebook). Also, for a dual-polarized antenna at an TRP, the inter-TRP phase can be the same for two polarizations of the TRP. Alternatively, it can be independent for two polarizations for the TRP. At least one of the following example is used for the inter-TRP phase reporting.
In one example, the inter-TRP phase is reported in a wideband (WB) manner, i.e., one value is reported for all SBs in the configured CSI reporting band. Due to WB reporting, it can be included in the W₁ component of the codebook. Alternatively, it can be included in a new component, say W₃ of the codebook.
In one example, the inter-TRP phase is reported in a subband (SB) manner, i.e., one value is reported for each SB in the configured CSI reporting band. Due to SB reporting, it can be included in the W₂ component of the codebook. Alternatively, it can be included in a new component, say W₃ of the codebook.
In one example, the inter-TRP phase is reported in a WB plus SB manner, i.e., one WB phase value is reported for all SBs in the configured CSI reporting band, and one SB value is reported for each SB in the configured CSI reporting band. Due to WB plus SB reporting, the WB part can be included in the W₁ component of the codebook and the SB part can be included in the W₂ component of the codebook. Alternatively, both WB and SB parts can be included in a new component, say W₃ of the codebook.

In one example, the additional components include inter-TRP phase and inter-TRP amplitude, wherein the details about the inter-TRP phase are as explained in example 0.18.1. Note that inter-TRP amplitude is needed due to unequal distance of the UE from TRPs. In one example, the inter-TRP amplitude values correspond to N_{TRP}−1 amplitude values (e.g., assuming one of the TRPs is a reference and has a fixed amplitude value=1). In another example, the inter-TRP amplitude values correspond to N_{TRP} amplitude values. The inter-TRP amplitude values can be quantized/reported as scalars using a scalar codebook (e.g., 2 bits per amplitude or 3 bits per amplitude) or as a vector using a vector codebook. Also, for a dual-polarized antenna at an TRP, the inter-TRP amplitude can be the same for two polarizations of the TRP. Alternatively, it can be independent for two polarizations for the TRP. At least one of the following example is used for the inter-TRP amplitude and phase reporting.
In one example, the inter-TRP amplitude is reported in a wideband (WB) manner, i.e., one value is reported for all SBs in the configured CSI reporting band. Due to WB reporting, it can be included in the W₁ component of the codebook. Alternatively, it can be included in a new component, say W₃ of the codebook. At least one of the following example is used for the inter-TRP phase.
   In one example, the inter-TRP phase is reported according to one or more examples described above.
In one example, the inter-TRP amplitude is reported in a subband (SB) manner, i.e., one value is reported for each SB in the configured CSI reporting band. Due to SB reporting, it can be included in the W₂ component of the codebook. Alternatively, it can be included in a new component, say W₃ of the codebook. At least one of the following example is used for the inter-TRP phase.
   In one example, the inter-TRP phase is reported according to one or more examples described above.
In one example, the inter-TRP amplitude is reported in a WB plus SB manner, i.e., one WB amplitude value is reported for all SBs in the configured CSI reporting band, and one SB value is reported for each SB in the configured CSI reporting band. Due to WB plus SB reporting, the WB part can be included in the W₁ component of the codebook and the SB part can be included in the W₂ component of the codebook. Alternatively, both WB and SB parts can be included in a new component, say W₃ of the codebook. At least one of the following example is used for the inter-TRP phase.
   In one example, the inter-TRP phase is reported according to one or more examples described above.

In one example, the additional components include inter-TRP amplitude, wherein the details about the inter-TRP amplitude are as explained according to one or more examples described above.

In one example, the additional components include inter-TRP power, wherein the details about the inter-TRP power are as explained according to one or more examples described above by replacing amplitude with power. In one example, a square of inter-TRP amplitude equals inter-TRP power.

In one example, the additional components include inter-TRP phase and inter-TRP power, wherein the details about the inter-TRP phase are as explained according to one or more examples described above, and the details about the inter-TRP power are as explained according to one or more examples described above by replacing amplitude with power. In one example, a square of inter-TRP amplitude equals inter-TRP power.

In one example, an inter-TRP phase codebook is TRP-common, i.e., a same inter-TRP phase codebook is used for all TRPs. It can be fixed or configured via higher-layer parameter, MAC-CE, or DCI. In one example, a 3-bit PSK codebook is used to select each of the N_{TRP}−1 inter-TRP phases.

In one example, an inter-TRP phase codebook is TRP-specific, i.e., a different inter-TRP phase codebook can be used for each TRP. It can be fixed or configured via higher-layer parameter, MAC-CE, or DCI. In one example, a 3-bit PSK codebook is used to select each of some inter-TRP phases and a 4-bit PSK codebook is used to select each of the other inter-TRP phases.

In one example, an inter-TRP amplitude (power) codebook is TRP-common, i.e., a same inter-TRP amplitude (power) codebook is used for all TRPs. It can be fixed or configured via higher-layer parameter, MAC-CE, or DCI. In one example, a 3-bit inter-TRP amplitude (power) codebook is used to select each of the N_{TRP}−1 inter-TRP amplitudes (powers).

In one example, an inter-TRP amplitude (power) codebook is TRP-specific, i.e., a different inter-TRP amplitude (power) codebook can be used for each TRP. It can be fixed or configured via higher-layer parameter, MAC-CE, or DCI. In one example, a 3-bit inter-TRP amplitude (power) codebook is used to select each of some inter-TRP amplitudes (powers) and a 4-bit inter-TRP amplitude (power) codebook is used to select each of the other inter-TRP amplitudes (powers).

In one example, inter-TRP amplitude (power) values are computed in a differential manner. For example, inter-TRP amplitude value can be computed as follows:

$${b}_{r} = {\prod }_{i = 1}^{r}$$

b̅ᵢ is the inter-TRP amplitude value for r-th strongest TRP, and b̅ᵢ for i≥2 is selected from an inter-TRP amplitude codebook and b̅₁=1. In another example, b̅ᵢ can be selected from a different inter-TRP amplitude codebook for each i≥2. In this case, {b̅ᵢ} for i≥2 are selected and reported and the NW computes inter-TRP amplitude using

$${b}_{r} = {\prod }_{i = 1}^{r} {\overline{b}}_{i} .$$

In one example, the additional components include an indicator indicating the strongest TRP (for reference). Due to distributed architecture, the strongest TRP can be reported in order to indicate the reference TRP with respect to which the inter-TRP components (such as amplitude and/or phase) are reported. The inter-TRP amplitude and phase associated with the strongest TRP can be set to a fixed value, for example 1. At least one of the following example is used for the strongest TRP reporting.
In one example, the strongest TRP (indicator) is reported in a WB manner, i.e., one value (indicator) is reported for all SBs. Due to WB reporting, it can be included in the W₁ component of the codebook. Alternatively, it can be included in a new component, say W₃ of the codebook.
In one example, the strongest TRP (indicator) is reported in a SB manner, i.e., one value (indicator) is reported for each SB. Due to SB reporting, it can be included in the W₂ component of the codebook. Alternatively, it can be included in a new component, say W₃ of the codebook.

In one example, the strongest TRP is reported in a layer-common manner, i.e., one strongest TRP is reported common for all layers when number of layers >1 (or rank >1).

In one example, the strongest TRP is reported in a layer-specific manner, i.e., one strongest TRP is reported for each layer of the number of layers when number of layers >1 (or rank >1).

The amplitude/phase associated with the strongest TRP can be fixed, e.g., to 1. In an alternate design, the strongest TRP can be configured (e.g., via RRC signaling), or can be fixed (e.g., TRP 1 is always strongest).

In one example, the additional components include an indicator indicating information on the order of strongest TRPs (or the order of weakest TRPs). At least one of the following example is used for the strongest TRP order reporting.
In one example, an indicator to indicate the strongest TRP order is reported in a WB manner, i.e., one indicator is reported for all SBs. Due to WB reporting, it can be included in the W₁ component of the codebook. Alternatively, it can be included in a new component, say W₃ of the codebook.
In one example, an indicator to indicate the strongest TRP order is reported in a SB manner, i.e., one indicator is reported for each SB. Due to SB reporting, it can be included in the W₂ component of the codebook. Alternatively, it can be included in a new component, say W₃ of the codebook.

In one example, the strongest TRP order is reported in a layer-common manner, i.e., one strongest TRP order is reported common for all layers when number of layers >1 (or rank >1).

In one example, the strongest TRP order is reported in a layer-specific manner, i.e., one strongest TRP order is reported for each layer of the number of layers when number of layers >1 (or rank >1).

The amplitude/phase associated with the strongest TRP can be fixed, e.g., to 1. In an alternate design, the strongest TRP or the strongest TRP order can be configured (e.g., via RRC signaling), or can be fixed (e.g., TRP 1/2/3/4 is always in the order of strongest TRPs)

In the present disclosure, the codebook component W₁ and W_{f} refer to pre-coder (or pre-coding matrix) components that are indicated via the components of the first PMI indicator i₁. Likewise, the codebook component W₂ refers to pre-coder (or pre-coding matrix) components that are indicated via the components of the second PMI indicator i₂. Likewise, the new codebook component W₃ refers to pre-coder (or pre-coding matrix) components that are indicated via the components of the third PMI indicator i₃.

In one embodiment, a UE is configured with a CSI report for N_{TRP}≥1 TRPs (or N_{TRP} NZP CSI-RS resources) based on a codebook, where the codebook is configured according to one or more embodiments described above. When N_{TRP}=1, a bit-map indicator for indicating non-zero coefficients for the codebook can be defined as the bit-map indicator in Rel-16/17 codebooks, i.e., which is as follows:

Let K₀=┌β2LM₁┐. The bitmap whose nonzero bits identify which coefficients in i_{2,4,l} and i_{2,5,l} are reported, is indicated by i_{1,7,l}

$${i}_{1 , 7 , l} = [ {k}_{l , 0}^{( 3 )} … {k}_{l , {M}_{υ} - 1}^{( 3 )} ]$$

$${k}_{l , f}^{( 3 )} = [ {k}_{l , 0 , f}^{( 3 )} … {k}_{l , 2 L - 1 , f}^{( 3 )} ]$$

$${k}_{l , i , f}^{( 3 )} ∈ \{ 0 , 1 \}$$

for l=1, . . . , v, such that

$${K}_{l}^{N Z} = {\sum }_{i = 0}^{2 L - 1} {\sum }_{f = 0}^{{M}_{υ} - 1} {k}_{l , i , f}^{( 3 )} \leq {K}_{0}$$

is the number of nonzero coefficients for layer l=1, . . . , v and

$${K}^{N Z} = {\sum }_{l = 1}^{υ} {K}_{l}^{N Z} \leq 2 {K}_{0}$$

is the total number of nonzero coefficients.

In one embodiment, when N_{TRP}≥1, a bitmap indicator whose nonzero bits identify which coefficients are reported (e.g., i_{2,4,l} and i_{2,5,l}) can be determined according to at least one of the following examples.

In one example, the bitmap indicator is polarization-specific (one for each polarization), layer-specific (one for each layer), and TRP-specific (one for each TRP). For example, the bitmap i_{1,7,l} can be expressed as

$${i}_{1 , 7 , l} = [ {k}_{l , 0 , r}^{( 3 )} … {k}_{l , {M}_{υ} - 1 , r}^{( 3 )} ]$$

$${k}_{l , f}^{( 3 )} = [ {k}_{l , 0 , f}^{( 3 )} … {k}_{l , 2 L - 1 , f}^{( 3 )} ]$$

$${k}_{l , i , f}^{( 3 )} = [ {k}_{l , i , f , 1}^{( 3 )} … {k}_{l , i , f , {N}_{TRP}}^{( 3 )} ]$$

$${k}_{l , i , f , r}^{( 3 )} ∈ \{ 0 , 1 \}$$

for l=1, . . . , v.

In one example, the bitmap indicator is polarization-common (one for both polarizations), layer-specific (one for each layer), and TRP-specific (one for each TRP). For example, the bitmap i_{1,7,l} can be expressed as

$${i}_{1 , 7 , l} = [ {k}_{l , 0 , r}^{( 3 )} … {k}_{l , {M}_{υ} - 1 , r}^{( 3 )} ]$$

$${k}_{l , f}^{( 3 )} = [ {k}_{l , 0 , f}^{( 3 )} … {k}_{l , L - 1 , f}^{( 3 )} ]$$

$${k}_{l , i , f}^{( 3 )} = [ {k}_{l , i , f , 1}^{( 3 )} … {k}_{l , i , f , {N}_{TRP}}^{( 3 )} ]$$

$${k}_{l , i , f , r}^{( 3 )} ∈ \{ 0 , 1 \}$$

for l=1, . . . , v, which is common for both polarizations. That is, the bitmap i_{1,7,l} common for both polarizations is reported.

In one example, the bitmap indicator is polarization-specific (one for each polarization), layer-common (one for all layers), and TRP-specific (one for each TRP). For example, the bitmap i_{1,7} can be expressed as

$${i}_{1 , 7} = [ {k}_{0 , r}^{( 3 )} … {k}_{{M}_{υ} - 1 , r}^{( 3 )} ]$$

$${k}_{f}^{( 3 )} = [ {k}_{0 , f}^{( 3 )} … {k}_{2 L - 1 , f}^{( 3 )} ]$$

$${k}_{i , f}^{( 3 )} = [ {k}_{i , f , 1}^{( 3 )} … {k}_{i , f , {N}_{T R P}}^{( 3 )} ]$$

$${k}_{i , f , r}^{( 3 )} ∈ \{ 0 , 1 \}$$

which is common for all layers l=1, . . . , v. That is, the bitmap i_{1,7} common for all layers is reported.

In one example, the bitmap indicator is polarization-common (one for both polarizations), layer-common (one for all layers), and TRP-specific (one for each TRP). For example, the bitmap i_{1,7} can be expressed as

$${i}_{1 , 7} = [ {k}_{0 , r}^{( 3 )} … {k}_{{M}_{v} - 1 , r}^{( 3 )} ] \\ {k}_{f}^{( 3 )} = [ {k}_{0 , f}^{( 3 )} … {k}_{L - 1 , f}^{( 3 )} ] \\ {k}_{i , f}^{( 3 )} = [ {k}_{i , f , 1}^{( 3 )} … {k}_{i , f , {N}_{TRP}}^{( 3 )} ] \\ {k}_{i , f , r}^{( 3 )} ∈ \{ 0 , 1 \}$$

which is common for all layers l=1, . . . , v and for both polarizations. That is, the bitmap i_{1,7} common for all layers and for both polarizations is reported.

In one example, the bitmap indicator is polarization-specific (one for each polarization), layer-specific (one for each layer), and TRP-common (one for all TRPs). For example, the bitmap i_{1,7,l} for each l=1, . . . , v can be expressed as

$${i}_{1 , 7 , l} = [ {k}_{l , 0}^{( 3 )} … {k}_{l , {M}_{v} - 1}^{( 3 )} ] \\ {k}_{l , f}^{( 3 )} = [ {k}_{l , 0 , f}^{( 3 )} … {k}_{l , 2 L - 1 , f}^{( 3 )} ] \\ {k}_{l , i , f}^{( 3 )} ∈ \{ 0 , 1 \}$$

which is common for all TRPs r=1, . . . , N_{TRP}. That is, the bitmap i_{1,7,l} common for all TRPs is reported.

In one example, the bitmap indicator is polarization-common (one for both polarizations), layer-specific (one for each layer), and TRP-common (one for all TRPs). For example, the bitmap i_{1,7,l} for each l=1, . . . , v can be expressed as

$${i}_{1 , 7 , l} = [ {k}_{l , 0}^{( 3 )} … {k}_{l , {M}_{v} - 1}^{( 3 )} ] \\ {k}_{l , f}^{( 3 )} = [ {k}_{l , 0 , f}^{( 3 )} … {k}_{l , L - 1 , f}^{( 3 )} ] \\ {k}_{l , i , f}^{( 3 )} ∈ \{ 0 , 1 \}$$

which is common for all TRPs r=1, . . . , N_{TRP} and for both polarizations. That is, one bitmap i_{1,7,l} common for all TRPs and both polarizations are reported.

In one example, the bitmap indicator is polarization-specific (one for each polarization), layer-common (one for all layers), and TRP-common (one for all TRPs). For example, the bitmap i_{1,7} can be expressed as

$${i}_{1 , 7} = [ {k}_{0}^{( 3 )} … {k}_{{M}_{v} - 1}^{( 3 )} ] \\ {k}_{f}^{( 3 )} = [ {k}_{0 , f}^{( 3 )} … {k}_{2 L - 1 , f}^{( 3 )} ] \\ {k}_{i , f}^{( 3 )} ∈ \{ 0 , 1 \}$$

which is common for all layers l=1, . . . , v and for all TRPs r=1, . . . , N_{TRP}. That is, one bitmap i_{1,7} common for all layers and for all TRPs is reported.

In one example, the bitmap indicator is polarization-common (one for both polarizations), layer-common (one for all layers), and TRP-common (one for all TRPs). For example, the bitmap i_{1,7} can be expressed as

$${i}_{1 , 7} = [ {k}_{0}^{( 3 )} … {k}_{{M}_{v} - 1}^{( 3 )} ] \\ {k}_{f}^{( 3 )} = [ {k}_{0 , f}^{( 3 )} … {k}_{L - 1 , f}^{( 3 )} ] \\ {k}_{i , f}^{( 3 )} ∈ \{ 0 , 1 \}$$

which is common for all layers l=1, . . . , v and for all TRPs r=1, . . . , N_{TRP} and for both polarizations. That is, one bitmap i_{1,7} common for all layers and for all TRPs and for both polarizations is reported.

When the number of FD basis vectors Mᵥ is independent for each TRP r (and L is common for all TRPs), Mᵥ can be replaced by M_{v,r}.
In one example, the bitmap can be determined according to one or more examples described above replacing My by M_{v,r}.

When the number of SD basis vectors L is independent for each TRP r (and Mᵥ is common for all TRPs), L can be replaced by Lᵣ.
In one example, the bitmap can be determined according to one or more examples described above replacing L by Lᵣ.

When the numbers of SD/FD basis vectors L and Mᵥ are independent for each TRP r, L and Mᵥ can be replaced by Lᵣ and M_{v,r}, respectively.
In one example, the bitmap can be determined according to one or more examples described above replacing L and Mᵥ by Lᵣ and M_{v,r}, respectively.

In one embodiment, an upper bound of the number of non-zero coefficients can be defined as at least one of the following examples.

In one example, the upper bound can be given by

$${K}_{l , r}^{NZ} = {\sum }_{i = 0}^{2 {L}_{r} - 1} {\sum }_{f = 0}^{{M}_{v , r} - 1} {k}_{l , i , f , r}^{( 3 )} \leq {K}_{0 , l , r}$$

per layer l per TRP r.
In another example,

$${K}_{l , r}^{NZ} = {\sum }_{i = 0}^{2 L - 1} {\sum }_{f = 0}^{{M}_{v , r} - 1} {k}_{l , i , f , r}^{( 3 )} \leq {K}_{0 , l , r} .$$

In another example,

$${K}_{l , r}^{NZ} = {\sum }_{i = 0}^{2 {L}_{r} - 1} {\sum }_{f = 0}^{{M}_{v} - 1} {k}_{l , i , f , r}^{( 3 )} \leq {K}_{0 , l , r} .$$

In another example,

$${K}_{l , r}^{NZ} = {\sum }_{i = 0}^{2 L - 1} {\sum }_{f = 0}^{{M}_{v} - 1} {k}_{l , i , f , r}^{( 3 )} \leq {K}_{0 , l , r} .$$

In one example, K_{0,l,r} is common for all TRPs, i.e., K_{0,l,r}=K_{0,l} for ∀r.

In one example, K_{0,l,r} is common for all layers, i.e., K_{0,l,r}=Kor for ∀l.

In one example, K_{0,l,r} is common for all layers and all TRPs, i.e., K_{0,l,r}=K₀ for ∀l.

In one example, K_{0,l,r} can be computed using parameters β (or βₗ, or βᵣ, or β_{l,r}, . . . ), L (or Lᵣ), M (or Mᵥ, or M_{v,r}), similar to the K₀ of Rel-16 codebook. Here the β can be given by at least one of the examples in one or more embodiments described above.
In one example, K_{0,l,r}=┌β2LM₁┐.
In one example, K_{0,l,r}=┌β2LM_{1,r}┐.
In one example, K_{0,l,r}=┌β2LᵣM₁┐.
In one example, K_{0,l,r}=┌β2LᵣM_{1,r}┐.
In one example, K_{0,l,r}=┌βₗ2LM₁┐.
In one example, K_{0,l,r}=┌βₗ2LM_{1,r}┐.
In one example, K_{0,l,r}=┌βₗ2LᵣM₁┐.
In one example, K_{0,l,r}=┌βₗ2LᵣM_{1,r}┐.
In one example, K_{0,l,r}=┌ᵣ2LM₁┐.
In one example, K_{0,l,r}=┌βᵣ2LM_{1,r}┐.
In one example, K_{0,l,r}=┌βᵣ2LᵣM1┐.
In one example, K_{0,l,r}=┌βᵣ2LᵣM_{1,r}┐.
In one example, K_{0,l,r}=┌βᵣ2LM₁┐.
In one example, K_{0,l,r}=┌β_{l,r}2LM_{1,r}┐.
In one example, K_{0,l,r}=┌β_{l,r}2LᵣM₁┐.
In one example, K_{0,l,r}=┌β_{l,r}2LᵣM_{1,r}┐.
In one example,

$${K}_{0 , l , r} = ⌈ \frac{{β}_{tot}}{N} 2 {LM}_{1} ⌉ .$$

In one example,

$${K}_{0 , l , r} = ⌈ \frac{{β}_{tot}}{N} 2 {LM}_{1 , r} ⌉ .$$

In one example,

$${K}_{0 , l , r} = ⌈ \frac{{β}_{tot}}{N} 2 {L}_{r} {M}_{1} ⌉ .$$

In one example,

$${K}_{0 , l , r} = ⌈ \frac{{β}_{tot}}{N} 2 {L}_{r} {M}_{1 , r} ⌉ .$$

In one example, K_{0,l,r}=┌β2LMᵥ┐.
In one example, K_{0,l,r}=┌β2LM_{v,r}┐.
In one example, K_{0,l,r}=┌β2LᵣMᵥ┐.
In one example, K_{0,l,r}=┌β2LᵣM_{v,r}┐.
In one example, K_{0,l,r}=┌βₗ2LMᵥ┐.
In one example, K_{0,l,r}=┌βₗ2LM_{v,r}┐.
In one example, K_{0,l,r}=┌βₗ2LᵣMᵥ┐.
In one example, K_{0,l,r}=┌βₗ2LᵣM_{v,r}┐.
In one example, K_{0,l,r}=┌βᵣ2LMᵥ┐.
In one example, K_{0,l,r}=┌βᵣ2LM_{v,r}┐.
In one example, K_{0,l,r}=┌βᵣ2LᵣMᵥ┐.
In one example, K_{0,l,r}=┌βᵣ2LᵣM_{v,r}┐.
In one example, K_{0,l,r}=┌β_{l,r}2LMᵥ┐.
In one example, K_{0,l,r}=┌β_{l,r}2LM_{v,r}┐.
In one example, K_{0,l,r}=K_{0,l,r}=┌β_{l,r}2LᵣMᵥ┐.
In one example, K_{0,l,r}=┌β2LᵣM_{v,r}┐.
In one example,

$${K}_{0 , l , r} = ⌈ \frac{{β}_{tot}}{N} 2 {LM}_{v} ⌉ .$$

In one example,

$${K}_{0 , l , r} = ⌈ \frac{{β}_{tot}}{N} 2 {LM}_{v , r} ⌉ .$$

In one example,

$${K}_{0 , l , r} = ⌈ \frac{{β}_{t o t}}{N} 2 {L}_{r} {M}_{v} ⌉ .$$

In one example,

$${K}_{0 , l , r} = ⌈ \frac{{β}_{t o t}}{N} 2 {L}_{r} {M}_{v , r} ⌉ .$$

In one example, the upper bound can be given by

$${K}_{l}^{NZ} = {\sum }_{r = 1}^{{N}_{TRP}} {\sum }_{i = 0}^{2 {L}_{r} - 1} {\sum }_{f = 0}^{{M}_{υ , r} - 1} {k}_{l , i , f , r}^{( 3 )} \leq {aK}_{0 , l}$$

per layer l. For example, a=1, a=2 or a=min(2, N_{TRP}).
In another example,

$${K}_{l}^{N Z} = {\sum }_{r = 1}^{{N}_{TRP}} {\sum }_{i = 0}^{2 L - 1} {\sum }_{f = 0}^{{M}_{υ , r} - 1} {k}_{l , i , f , r}^{( 3 )} \leq {aK}_{0 , l} .$$

In another example,

$${K}_{l}^{N Z} = {\sum }_{r = 1}^{{N}_{TRP}} {\sum }_{i = 0}^{2 {L}_{r} - 1} {\sum }_{f = 0}^{{M}_{υ} - 1} {k}_{l , i , f , r}^{( 3 )} \leq a {K}_{0 , l} .$$

In another example,

$${K}_{l}^{N Z} = {\sum }_{r = 1}^{{N}_{TRP}} {\sum }_{i = 0}^{2 L - 1} {\sum }_{f = 0}^{{M}_{υ} - 1} {k}_{l , i , f , r}^{( 3 )} \leq {aK}_{0 , l} .$$

In one example, K_{0,l} is common for all layers, i.e., K_{0,l}=K₀ for ∀l.

In one example, K_{0,l} can be computed using parameters β (or βₗ, or βₜₒₜ, . . . ), L (or Lᵣ), M (or Mᵥ, or M_{v,r}), similar to the K₀ of Rel-16 codebook. Here the β can be given by at least one of the examples in one or more embodiments described above.
In one example, K_{0,l}=┌β2LM₁┐.
In one example, K_{0,l}=┌β2LM₁N┐.
In one example,

$${K}_{0 , l} = ⌈ β 2 L {\sum }_{r = 1}^{N} {M}_{1 , r} ⌉ .$$

In one example,

$${K}_{0 , l} = ⌈ β 2 {M}_{1} {\sum }_{r = 1}^{N} {L}_{r} ⌉ .$$

In one example,

$${K}_{0 , l} = ⌈ β 2 {\sum }_{r = 1}^{N} {L}_{r} {M}_{1 , r} ⌉ .$$

In one example, K_{0,l}=┌βₗ2LM₁┐.
In one example, K_{0,l}=┌βₗ2LM₁N┐.
In one example,

$${K}_{0 , l} = ⌈ {β}_{l} 2 L {\sum }_{r = 1}^{N} {M}_{1 , r} ⌉ .$$

In one example,

$${K}_{0 , l} = ⌈ {β}_{l} 2 {M}_{1} {\sum }_{r = 1}^{N} {L}_{r} ⌉ .$$

In one example,

$${K}_{0 , l} = ⌈ {β}_{l} 2 {\sum }_{r = 1}^{N} {L}_{r} {M}_{1 , r} ⌉ .$$

In one example, K_{0,l}=┌βₜₒₜ2LM₁┐.
In one example, K_{0,l}=┌βₜₒₜ2LM₁N┐.
In one example,

$${K}_{0 , l} = ⌈ {β}_{tot} 2 L {\sum }_{r = 1}^{N} {M}_{1 , r} ⌉ .$$

In one example,

$${K}_{0 , l} = ⌈ {β}_{tot} 2 {M}_{1} {\sum }_{r = 1}^{N} {L}_{r} ⌉ .$$

In one example,

$${K}_{0 , l} = ⌈ {β}_{tot} 2 {\sum }_{r = 1}^{N} {L}_{r} {M}_{1 , r} ⌉ .$$

In one example, K_{0,l}=┌β2LMᵥ┐.
In one example, K_{0,l}=┌β2LMᵥN┐.
In one example,

$${K}_{0 , l} = ⌈ β2 L {\sum }_{r = 1}^{N} {M}_{v , r} ⌉ .$$

In one example,

$${K}_{0 , l} = ⌈ β 2 {M}_{v} {\sum }_{r = 1}^{N} {L}_{r} ⌉ .$$

In one example,

$${K}_{0 , l} = ⌈ β2 {\sum }_{r = 1}^{N} {L}_{r} {M}_{v , r} ⌉ .$$

In one example, K_{0,l}=┌βₗ2LMᵥ┐.
In one example, K_{0,l}=┌βₗ2LMᵥN┐.
In one example,

$${K}_{0 , l} = ⌈ {β}_{l} 2 L {\sum }_{r = 1}^{N} {M}_{v , r} ⌉ .$$

In one example,

$${K}_{0 , l} = ⌈ {β}_{l} 2 {M}_{v} {\sum }_{r = 1}^{N} {L}_{r} ⌉ .$$

In one example,

$${K}_{0 , l} = ⌈ {β}_{l} 2 {\sum }_{r = 1}^{N} {L}_{r} {M}_{v , r} ⌉ .$$

In one example, K_{0,l}=┌βₜₒₜ2LMᵥ┐.
In one example, K_{0,l}=┌βₜₒₜ2LMᵥN┐.
In one example,

$${K}_{0 , l} = ⌈ {β}_{tot} 2 L {\sum }_{r = 1}^{N} {M}_{v , r} ⌉ .$$

In one example,

$${K}_{0 , l} = ⌈ {β}_{tot} 2 {M}_{v} {\sum }_{r = 1}^{N} {L}_{r} ⌉ .$$

In one example,

$${K}_{0 , l} = ⌈ {β}_{tot} 2 {\sum }_{r = 1}^{N} {L}_{r} {M}_{v , r} ⌉ .$$

In one example, the upper bound can be given by

$${K}_{r}^{N Z} = {\sum }_{l = 1}^{v} {\sum }_{i = 0}^{2 {L}_{r} - 1} {\sum }_{f = 0}^{{M}_{υ , r} - 1} {k}_{l , i , f , r}^{( 3 )} \leq b {K}_{0 , r}$$

per TRP r. For example, b=1, b=2 or b=min (2, v).
In another example,

$${K}_{r}^{N Z} = {\sum }_{l = 1}^{v} {\sum }_{i = 0}^{2 L - 1} {\sum }_{f = 0}^{{M}_{υ , r} - 1} {k}_{l , i , f , r}^{( 3 )} \leq b {K}_{0 , r} .$$

In another example,

$${K}_{r}^{N Z} = {\sum }_{l = 1}^{v} {\sum }_{i = 0}^{2 {L}_{r} - 1} {\sum }_{f = 0}^{{M}_{υ} - 1} {k}_{l , i , f , r}^{( 3 )} \leq b {K}_{0 , r} .$$

In another example,

$${K}_{r}^{N Z} = {\sum }_{l = 1}^{v} {\sum }_{i = 0}^{2 L - 1} {\sum }_{f = 0}^{{M}_{υ} - 1} {k}_{l , i , f , r}^{( 3 )} \leq b {K}_{0 , r} .$$

In one example, K_{0,r} is common for all TRPs, i.e., K_{0,4}=K₀ for ∀l.

In one example, K_{0,r} can be computed using parameters β (or βᵣ, or βₜₒₜ, . . . ), L (or Lᵣ), M (or Mᵥ, or M_{v,r}), similar to the K₀ of Rel-16 codebook. Here the β can be given by at least one of the examples in one or more embodiments described above.
In one example, K_{0,r}=┌β2LM₁┐.
In one example, K_{0,r}=┌β2LM_{1,r}┐.
In one example, K_{0,r}=┌β2LᵣM₁┐.
In one example, K_{0,r}=┌β2LᵣM_{1,r}┐.
In one example, K_{0,r}=┌βᵣ2LM₁┐.
In one example, K_{0,r}=┌βᵣ2LM_{1,r}┐.
In one example, K_{0,r}=┌βᵣ2LᵣM₁┐.
In one example, K_{0,r}=┌βᵣ2LᵣM_{1,r}┐.
In one example,

$${K}_{0 , r} = ⌈ \frac{{β}_{t o t}}{N} 2 {LM}_{1} ⌉ .$$

In one example,

$${K}_{0 , r} = ⌈ \frac{{β}_{t o t}}{N} 2 {LM}_{1 , r} ⌉ .$$

In one example,

$${K}_{0 , r} = ⌈ \frac{{β}_{t o t}}{N} 2 {L}_{r} {M}_{1} ⌉ .$$

In one example,

$${K}_{0 , r} = ⌈ \frac{{β}_{t o t}}{N} 2 {L}_{r} {M}_{1 , r} ⌉ .$$

In one example, K_{0,r}=┌β2LMᵥ┐.
In one example, K_{0,r}=┌β2LM_{v,r}┐.
In one example, K_{0,r}=┌β2LᵣMᵥ┐.
In one example, K_{0,r}=┌β2LᵣM_{v,r}┐.
In one example, K_{0,r}=┌βᵣ2LMᵥ┐.
In one example, K_{0,r}=┌βᵣ2LM_{v,r}┐.
In one example, K_{0,r}=┌βᵣ2LᵣMᵥ┐.
In one example, K_{0,r}=┌βᵣ2LᵣM_{v,r}┐.
In one example,

$${K}_{0 , r} = ⌈ \frac{{β}_{t o t}}{N} 2 {LM}_{v} ⌉ .$$

In one example,

$${K}_{0 , r} = ⌈ \frac{{β}_{t o t}}{N} 2 {LM}_{v , r} ⌉ .$$

In one example,

$${K}_{0 , r} = ⌈ \frac{{β}_{t o t}}{N} 2 {L}_{r} {M}_{v} ⌉ .$$

In one example,

$${K}_{0 , r} = ⌈ \frac{{β}_{t o t}}{N} 2 {L}_{r} {M}_{v , r} ⌉ .$$

In one example, the upper bound can be given by

$${K}^{N Z} = {\sum }_{l = 1}^{v} {K}_{l}^{N Z} \leq c {K}_{0} .$$

For example, c=1, c=2 or c=min(2, v).

In one example, K₀ can be computed using parameters β (or βₜₒₜ) . . . ), L (or Lᵣ), M (or Mᵥ, or M_{v,r}), similar to the K₀ of Rel-16 codebook. Here the β can be given by at least one of the examples in one or more embodiments described above.
In one example, K₀=┌β2LM₁┐.
In one example, K₀=┌β2LM₁N┐.
In one example,

$${K}_{0} = ⌈ β 2 L {\sum }_{r = 1}^{N} {M}_{1 , r} ⌉ .$$

In one example,

$${K}_{0} = ⌈ β 2 {M}_{1} {\sum }_{r = 1}^{N} {L}_{r} ⌉ .$$

In one example,

$${K}_{0} = ⌈ β 2 {\sum }_{r = 1}^{N} {L}_{r} {M}_{1 , r} ⌉ .$$

In one example, K₀=┌βₗ2LM₁┐.
In one example, K₀=┌βₗ2LM₁N┐.
In one example,

$${K}_{0} = ⌈ {β}_{l} 2 L {\sum }_{r = 1}^{N} {M}_{1 , r} ⌉ .$$

In one example,

$${K}_{0} = ⌈ {β}_{l} 2 {M}_{1} {\sum }_{r = 1}^{N} {L}_{r} ⌉ .$$

In one example,

$${K}_{0} = ⌈ {β}_{l} 2 {\sum }_{r = 1}^{N} {L}_{r} {M}_{1 , r} ⌉ .$$

In one example, K₀=┌βₜₒₜ2LM₁┐.
In one example, K₀=┌βₜₒₜ2LM₁N┐.
In one example,

$${K}_{0} = ⌈ {β}_{tot} 2 L {\sum }_{r = 1}^{N} {M}_{1 , r} ⌉ .$$

In one example,

$${K}_{0} = ⌈ {β}_{tot} 2 {M}_{1} {\sum }_{r = 1}^{N} {L}_{r} ⌉ .$$

In one example,

$${K}_{0} = ⌈ {β}_{tot} 2 {\sum }_{r = 1}^{N} {L}_{r} {M}_{1 , r} ⌉ .$$

In one example, K₀=┌β2LMᵥ┐.
In one example, K₀=┌β2LMᵥN┐.
In one example,

$${K}_{0} = ⌈ β 2 L {\sum }_{r = 1}^{N} {M}_{v , r} ⌉ .$$

In one example,

$${K}_{0} = ⌈ β 2 {M}_{1} {\sum }_{r = 1}^{N} {L}_{r} ⌉ .$$

In one example,

$${K}_{0} = ⌈ β 2 {\sum }_{r = 1}^{N} {L}_{r} {M}_{v , r} ⌉ .$$

In one example, K₀=┌βₗ2LMᵥ┐.
In one example, K₀=[βₗ2LMᵥN].
In one example,

$${K}_{0} = ⌈ {β}_{l} 2 L {\sum }_{r = 1}^{N} {M}_{v , r} ⌉ .$$

In one example,

$${K}_{0} = ⌈ {β}_{l} 2 {M}_{v} {\sum }_{r = 1}^{N} {L}_{r} ⌉ .$$

In one example,

$${K}_{0} = ⌈ {β}_{l} 2 {\sum }_{r = 1}^{N} {L}_{r} {M}_{v , r} ⌉ .$$

In one example, K₀=┌βₜₒₜ2LMᵥ┐.
In one example, K₀=┌βₜₒₜ2LMᵥN┐.
In one example,

$${K}_{0} = ⌈ {β}_{tot} 2 L {\sum }_{r = 1}^{N} {M}_{v , r} ⌉ .$$

In one example,

$${K}_{0} = ⌈ {β}_{tot} 2 {M}_{v} {\sum }_{r = 1}^{N} {L}_{r} ⌉ .$$

In one example,

$${K}_{0} = ⌈ {β}_{tot} 2 {\sum }_{r = 1}^{N} {L}_{r} {M}_{v , r} ⌉ .$$

In one example, any combination (or joint constraint) of upper bounds described in one or more examples described above can be an upper bound for the number of non-zero coefficient.
For example, the upper bound can be given by

$${K}_{l , r}^{N Z} = {\sum }_{i = 0}^{2 {L}_{r} - 1} {\sum }_{f = 0}^{{M}_{υ , r} - 1} {k}_{l , i , f , r}^{( 3 )} \leq {K}_{0 , l , r}$$

$$and$$

$${K}_{l}^{N Z} = {\sum }_{r = 1}^{{N}_{T R P}} {\sum }_{i = 0}^{2 {L}_{r} - 1} {\sum }_{f = 0}^{{M}_{υ , r} - 1} {k}_{l , i , f , r}^{( 3 )} \leq a {K}_{0 , l}$$

(i.e., the upper bound that intersects both of an upper bound described in examples described above).
For example, the upper bound can be given by

$${K}_{l , r}^{N Z} = {\sum }_{i = 0}^{2 {L}_{r} - 1} {\sum }_{f = 0}^{{M}_{υ , r} - 1} {k}_{l , i , f , r}^{( 3 )} \leq {K}_{0 , l , r}$$

$$and$$

$${K}_{r}^{N Z} = {\sum }_{l = 1}^{v} {\sum }_{i = 0}^{2 {L}_{r} - 1} {\sum }_{f = 0}^{{M}_{υ , r} - 1} {k}_{l , i , f , r}^{( 3 )} \leq b {K}_{0 , r}$$

(i.e., the upper bound that intersects both of an upper bound described in examples described above).
For example, the upper bound can be given by

$${K}_{l , r}^{N Z} = {\sum }_{i = 0}^{2 {L}_{r} - 1} {\sum }_{f = 0}^{{M}_{υ , r} - 1} {k}_{l , i , f , r}^{( 3 )} \leq {K}_{0 , l , r}$$

$$and$$

$${K}^{N Z} = {\sum }_{l = 1}^{v} {K}_{l}^{N Z} \leq {K}_{0}$$

(i.e., the upper bound that intersects both of an upper bound described in examples described above).
For example, the upper bound can be given by

$${K}_{l}^{N Z} = {\sum }_{r = 1}^{{N}_{T R P}} {\sum }_{i = 0}^{2 {L}_{r} - 1} {\sum }_{f = 0}^{{M}_{υ , r} - 1} {k}_{l , i , f , r}^{( 3 )} \leq {aK}_{0 , l}$$

$$and$$

$${K}_{r}^{N Z} = {\sum }_{l = 1}^{v} {\sum }_{i = 0}^{2 {L}_{r} - 1} {\sum }_{f = 0}^{{M}_{υ , r} - 1} {k}_{l , i , f , r}^{( 3 )} \leq b {K}_{0 , r}$$

(i.e., the upper bound that intersects both of an upper bound described in examples described above).
For example, the upper bound can be given by

$${K}_{l}^{N Z} = {\sum }_{r = I}^{{N}_{T R P}} {\sum }_{i = 0}^{2 {L}_{r} - 1} {\sum }_{f = 0}^{{M}_{υ , r} - 1} {k}_{l , i , f , r}^{( 3 )} \leq$$

$$and$$

$$a {K}_{0 , l} and {K}^{N Z} = {\sum }_{l = 1}^{v} {K}_{l}^{N Z} \leq {K}_{0}$$

(i.e., the upper bound that intersects both of an upper bound described in examples described above).
For example, the upper bound can be given by

$${K}_{r}^{N Z} = {\sum }_{l = 1}^{v} {\sum }_{i = 0}^{2 {L}_{r} - 1} {\sum }_{f = 0}^{{M}_{υ , r} - 1} {k}_{l , i , f , r}^{( 3 )} \leq b {K}_{0 , r}$$

$$and$$

$${K}^{N Z} = {\sum }_{l = 1}^{v} {K}_{l}^{N Z} \leq {K}_{0}$$

(i.e., the upper bound that intersects both of an upper bound described in examples described above).

In one example, the upper bound can be rank-dependent v, i.e., an independent upper bound for each rank v. For example, an upper bound described in one or more examples described above is the upper bound for a rank v.

In one example, an upper bound can be rank-pair-specific, i.e., an independent upper bound for each rank-pair. For example, an upper bound described in one or more examples described above is the upper bound for a rank pair (e.g., v=1,2 or v=3,4).
For example, for rank pair v=1, 2, the upper bound can be given by

$${K}_{l}^{N Z} = {\sum }_{r = 1}^{{N}_{T R P}} {\sum }_{i = 0}^{2 {L}_{r} - 1} {\sum }_{f = 0}^{{M}_{υ , r} - 1} {k}_{l , i , f , r}^{( 3 )} \leq a {K}_{0 , l}$$

(i.e., an upper bound described in one or more examples described above). For rank pair v=3,4, the upper bound can be given by

$${K}_{l}^{N Z} = {\sum }_{r = 1}^{{N}_{T R P}} {\sum }_{i = 0}^{2 {L}_{r} - 1} {\sum }_{f = 0}^{{M}_{υ , r} - 1} {k}_{l , i , f , r}^{( 3 )} \leq a {K}_{0 , l}$$

$$and$$

$${K}^{N Z} = {\sum }_{l = 1}^{v} {K}_{l}^{N Z} \leq {K}_{0}$$

(i.e., un upper bound described in one or more examples described above).

In frequency division duplex (FDD) systems, DL channel state information is acquired at NW via a CSI feedback mechanism in 5G NR, wherein the NW transmits CSI-RS to a UE, the UE measures the CSI-RS, estimates DL channels, and reports DL CSI to the NW. This CSI feedback mechanism is essential for NW to acquire DL CSI, which is only available at the UE side in FDD, since the NW requires the DL CSI to design SU- or MU-MIMO beamforming.

Currently, AI/ML-based approaches have been developed in many research areas including image processing, robotics, and wireless communications, because AI/ML-based algorithms can develop/identify underlying mapping/function or relationship, (which usually cannot be mathematically modelled) between input and output based on given data, and have already been validated in several areas about their practicality. Due to the favorable aspect, 3GPP adopts AI/ML for air interface as a study item in Rel-18 in order to find useful use cases for AI/ML-based air-interface.

So far, in FDD, UL channels can be partially exploited to infer DL channels based on channel modeling in a mathematical form, and other remaining information that cannot be inferred based on the modeling is obtained via the CSI feedback mechanism in NR (e.g., using Rel-17 CSI codebook). Or the NW fully relies on the CSI feedback from the UE to acquire DL CSI, e.g., using Rel-15/16 CSI codebook. With AI/ML approaches, however, an underlying function/mapping/relationship between UL and DL channels in a given environment can be trained using UL and DL channel data. This disclosure proposes an air-interface framework wherein NW and UE exchange signals for NW to be able to train an AI/ML-based algorithm such as UL-to-DL channel mapping. In one aspect UL channels are available at NW, but DL channels are available at UE. In order to train an AI/ML-based algorithm for UL-to-DL channel mapping operation, a loss function should be computed based on inferred DL channels (through the AI/ML-based algorithm) and actual DL channels to update parameters of the algorithm in minimizing the loss function. However, the NW is not able to directly access actual DL channels, and thus, several signaling procedures need to be defined to resolve the issue.

This present disclosure proposes a framework wherein NW signals the UE to measure DL RS and compute a loss function based on the measured DL RS and some configured/indicated target information, and perform reporting of information for the NW to train its own algorithm.

The framework proposed in the present disclosure can be applicable in both TDD and FDD scenarios. Note that even in TDD scenarios, due to hardware impairments in the circuitry of transmit and receive antenna RF chains, UL and DL channel reciprocity may not hold, and thus, NW may need those approaches and can use the framework of this disclosure to train its AI/ML-based UL-to-DL channel mapping algorithm.

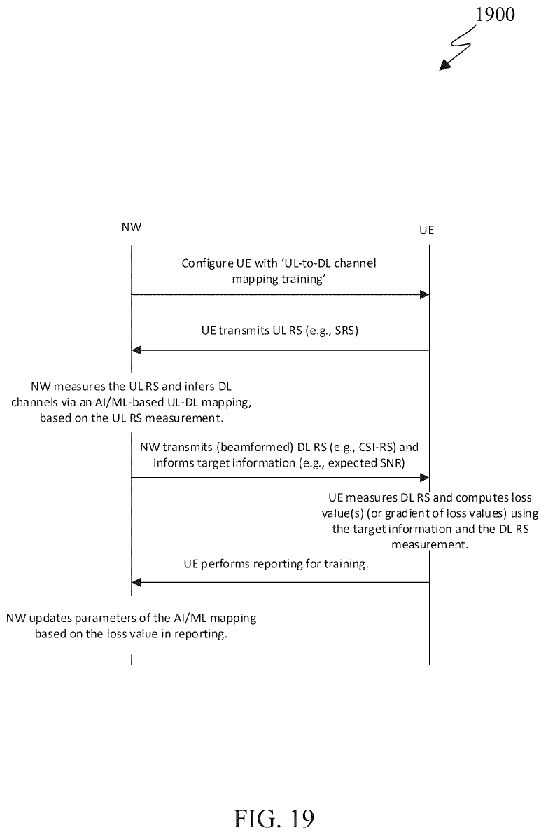

FIG. 19 illustrates an example signal flow 1900 for UL-to-DL channel mapping training according to embodiments of the present disclosure. The embodiment of the example signal flow 1900 for UL-to-DL channel mapping training illustrated in FIG. 19 is for illustration only. FIG. 19 does not limit the scope of this disclosure to any particular implementation of the example signal flow for UL-to-DL channel mapping training.

In one embodiment, a UE is configured with a “UL-to-DL channel mapping training”, wherein the UE is configured to perform UL RS transmission(s), perform DL RS reception(s), receive associated target information, and/or report information for UL-to-DL channel mapping training. This configuration can be performed via higher-layer (RRC) signaling. Optionally, DL RS reception, target information reception, and training information reporting can be dynamically triggered via L1 or L2 signaling (PDCCH or MAC-CE). FIG. 5 shows an illustration of signal flow for the UL-to-DL channel mapping training between NW and UE.

The three steps depicted in the flow diagram of FIG. 19 (UE transmission of UL RS, UE reception of DL RS and associated target information, and UE reporting of training information) can be configured or activated jointly. Optionally, at least one of the three steps can be configured or activated separately. Optionally, all the three steps can be configured or activated separately. For instance, the UE can be configured or triggered (in case of semi-persistent and aperiodic SRS) to transmit SRS separately (as it normally is). But the reception of the DL RS (such as aperiodic CSI-RS) and target information can be configured and/or triggered jointly with the reporting of the information for the UL-to-DL channel mapping training. In one example, this joint triggering can be performed via one or more dedicated triggering states (higher-layer configured) using the CSI request DCI field. Any combination of the three steps can be configured periodically, semi-persistently, or aperiodically.

In one embodiment, target information X includes quantity(-ies), which is used for UE to determine information (e.g., on loss values) for UL-to-DL channel mapping training.

In one example, target information X includes (target or expected) channel magnitudes (or channel powers or channel coefficient amplitudes). The channel magnitudes are indicated/configured with at least one of the following examples.
In one example, channel magnitudes are indicated in a subband (SB) (or other granularity) manner, i.e., each channel magnitude is associated with one corresponding SB. Each of the channel magnitude is selected from a set (e.g., amplitude codebook) and indicated/configured to the UE.
In one example, a channel magnitude is indicated in a wideband (WB) manner, i.e., one channel magnitude is associated with one whole configured WB or CSI reporting band. The channel magnitude is selected from a set (e.g., amplitude codebook) and indicated/configured to the UE.
In one example, channel magnitudes are indicated in a WB plus SB manner, i.e., one channel magnitude is associated with one whole configured WB, and other channel magnitudes are associated with SBs.
   In one example, the channel magnitude associated with the whole configured WB is a reference channel magnitude and the other channel magnitudes associated with SBs are determined in a differential manner based on the reference channel magnitude. For example, the reference channel magnitude X_{R} is selected/indicated from a set C_{Ref}, and each SB channel magnitude Xᵢ for SB i is defined as Xᵢ=X_{R}+ΔXᵢ, where ΔXₗ is selected/indicated from another set C_{SB}. In this example, X_{R} and {ΔXᵢ} are configured/indicated to the UE.

In this example, the UE can be configured with at least one DL RS (e.g., NZP CSI-RS resource or SSB) that is associated with or linked to the target information X.

In one example, target information X includes (target or expected) SNR value(s). The SNR values are indicated/configured with at least one of the following examples.
In one example, SNR values are indicated in a SB (or other granularity) manner, i.e., each SNR value is associated with one corresponding SB. Each of the SNR value is selected from a set and indicated/configured to the UE.
In one example, a SNR value is indicated in a WB manner, i.e., one SNR value is associated with one whole configured WB. The SNR value is selected from a set and indicated/configured to the UE.
In one example, SNR values are indicated in a WB plus SB manner, i.e., one SNR value is associated with one whole configured WB, and other SNR values are associated with SBs.
   In one example, the SNR value associated with the whole configured WB is a reference SNR and the other SNR values associated with SBs are determined in a differential manner based on the reference SNR. For example, the reference SNR X_{R} is selected/indicated from a set C_{Ref}, and each SB SNR Xᵢ for SB i is defined as Xᵢ=X_{R}+ΔXᵢ, where ΔXᵢ is selected/indicated from another set C_{SB}. In this example, X_{R} and {ΔXᵢ} are configured/indicated to the UE.

In this example, the UE can be configured with at least one DL RS (e.g., NZP CSI-RS resource or SSB) for signal part of the SNR values that is associated with or linked to the target information X.

In one example, target information X includes (target or expected) SINR value(s). The SINR values are indicated/configured with at least one of the following examples.
In one example, SINR values are indicated in a SB (or other granularity) manner, i.e., each SINR value is associated with one corresponding SB. Each of the SINR value is selected from a set and indicated/configured to the UE.
In one example, a SINR value is indicated in a WB manner, i.e., one SINR value is associated with one whole configured WB. The SINR value is selected from a set and indicated/configured to the UE.
In one example, SINR values are indicated in a WB plus SB manner, i.e., one SINR value is associated with one whole configured WB, and other SINR values are associated with SBs.
   In one example, the SINR value associated with the whole configured WB is a reference SINR and the other SINR values associated with SBs are determined in a differential manner based on the reference SINR. For example, the reference SINR X_{R} is selected/indicated from a set C_{Ref}, and each SB SINR Xᵢ for SB i is defined as Xᵢ=X_{R}+ΔXᵢ, where ΔXᵢ is selected/indicated from another set C_{SB}. In this example, X_{R} and {ΔXᵢ} are configured/indicated to the UE.

In this example, the UE can be configured with at least one DL RS (e.g., NZP CSI-RS resource or SSB) for signal part of the SINR value, and at least one interference RS (e.g., NZP CSI-RS resource or CSI-IM resource) for signal part of the SINR value, that are associated with or linked to the target information X.

In one example, target information X includes (target or expected) RSRP value(s). The RSRP values are indicated/configured with at least one of the following examples.
In one example, RSRP values are indicated in a SB (or other granularity) manner, i.e., each RSRP value is associated with one corresponding SB. Each of the RSRP value is selected from a set and indicated/configured to the UE.
In one example, a RSRP value is indicated in a WB manner, i.e., one RSRP value is associated with one whole configured WB. The RSRP value is selected from a set and indicated/configured to the UE.
In one example, RSRP values are indicated in a WB plus SB manner, i.e., one RSRP value is associated with one whole configured WB, and other RSRP values are associated with SBs.
   In one example, the RSRP value associated with the whole configured WB is a reference RSRP and the other RSRP values associated with SBs are determined in a differential manner based on the reference RSRP. For example, the reference RSRP X_{R} is selected/indicated from a set C_{Ref}, and each SB RSRP Xᵢ for SB i is defined as Xᵢ=X_{R}+ΔXᵢ, where ΔXᵢ is selected/indicated from another set C_{SB}. In this example, X_{R} and {ΔXᵢ} are configured/indicated to the UE.

In one example, target information X includes (target or expected) RSRQ value(s).

The RSRQ values are indicated/configured with at least one of the following examples.
In one example, RSRQ values are indicated in a SB (or other granularity) manner, i.e., each RSRQ value is associated with one corresponding SB. Each of the RSRQ value is selected from a set and indicated/configured to the UE.
In one example, a RSRQ value is indicated in a WB manner, i.e., one RSRQ value is associated with one whole configured WB. The RSRQ value is selected from a set and indicated/configured to the UE.
In one example, RSRQ values are indicated in a WB plus SB manner, i.e., one RSRQ value is associated with one whole configured WB, and other RSRQ values are associated with SBs.
   In one example, the RSRQ value associated with the whole configured WB is a reference RSRQ and the other RSRQ values associated with SBs are determined in a differential manner based on the reference RSRQ. For example, the reference RSRQ X_{R} is selected/indicated from a set C_{Ref}, and each SB RSRQ Xᵢ for SB i is defined as Xᵢ=X_{R}+ΔXᵢ, where ΔX is selected/indicated from another set C_{SB}. In this example, X_{R} and {ΔXᵢ} are configured/indicated to the UE.

In one embodiment, target information X is indicated/configured via higher-layer parameter, or MAC-CE, or DCI (PDCCH), or PDSCH, or a combination of at least two of RRC, MAC CE, and DCI.

In one embodiment, target information X is associated with the DL RS (e.g., NZP CSI-RS or SSB), and the number of values in the target information X is determined based on report configuration for the DL RS (e.g., CSI report). For example, a CSI report configuration includes reportFreqConfiguration to configure a plurality of SBs or WB CQIs/PMIs report. Similarly, the number of values in target information X corresponds to the number of SBs configured in a report configuration for the DL RS associated with the ‘UL-to-DL mapping training’ operation.

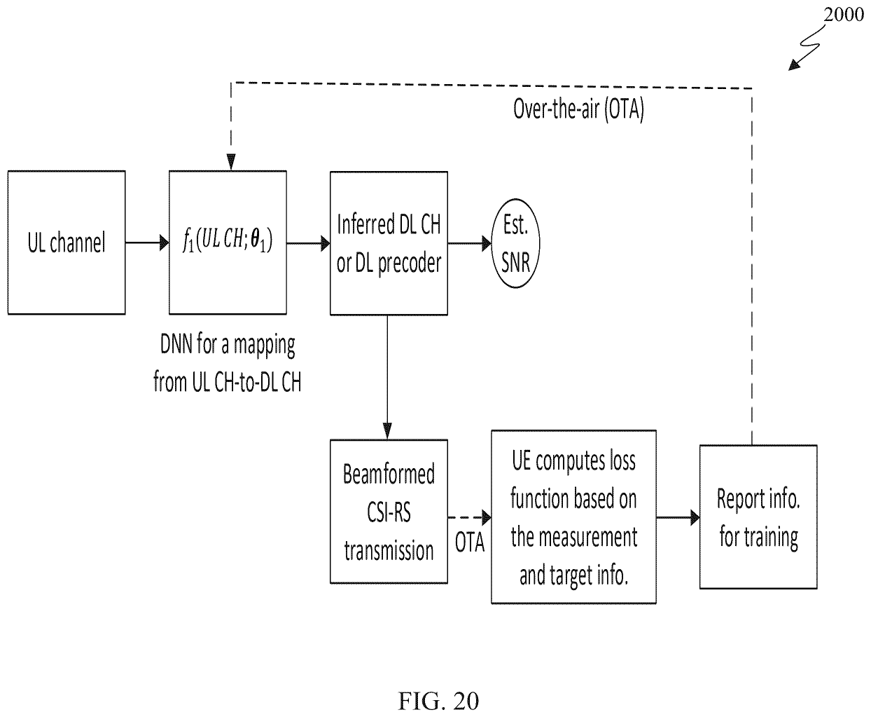

FIG. 20 illustrates an example block diagram 2000 where a UL channel to DL channel mapping is trained through over-the-air (OTA) signaling according to embodiments of the present disclosure. The embodiment of the example block diagram 2000 where a UL channel to DL channel mapping is trained through over-the-air (OTA) signaling illustrated in FIG. 20 is for illustration only. FIG. 20 does not limit the scope of this disclosure to any particular implementation of the example block diagram 2000 where a UL channel to DL channel mapping is trained through over-the-air (OTA) signaling.

In one embodiment, a UE is configured to perform DL RS reception (e.g., NZP CSI-RS or SSB) with N+1 antenna ports, where N is a number of (e.g., CSI-RS) antenna ports of the DL RS for UL-to-DL channel training. In one example, the N+1 ports can be partitioned into two groups, one group having N ports and the other group having one port. The group having N ports is for measuring (pure) DL channel, and the other group having one port is for measuring DL channel, which is the resultant DL channel when NW designs beamformed DL RS based on inferred DL channel from its AI/ML UL-to-DL channel mapping algorithm. In one example, N+1 antenna ports (e.g., CSI-RS ports) can belong two separate CSI-RS resources, one with N ports and another with 1 port. The configuration of the two resources can be separate (e.g., via two separate RRC configuration) or joint (e.g., one joint RRC configuration). In one example, two separate CSI-RS resources are linked or associated for UE to compute (pure) DL channels and beamformed DL channels correctly.

In one example, for the group having N ports, the NW transmits (non-beamformed) CSI-RS, and the UE measures the CSI-RS and estimates DL channel h_{DL,k} for SB k (or other frequency unit k), (we assume that the UE has one antenna port for the sake of simplicity but it can be extended to the case of multiple antenna ports at the UE), and for the group having one port, the NW transmits beamformed CSI-RS where matched-filter (MF) beamforming is designed based on the inferred DL channel, i.e., vₖ=αₖĥ_{DL,k}, where αₖ is a power scaling factor and ĥ_{DL,k} is the inferred DL channel from an AI/ML algorithm at the NW, and the UE measures the beamformed CSI-RS and estimates the resultant DL channel

$${α}_{k} {h}_{D L , k}^{H} {\hat{h}}_{D L , k} .$$

Note that once the UE estimates h_{DL,k} and

$${α}_{k} {h}_{D L , k}^{H} {\hat{h}}_{D L , k} ,$$

the UE can compute cosine similarity between h_{DL,k} and ĥ_{DL,k} based on simple manipulation,

$$CS ( {\hat{h}}_{D L , k} {\hat{h}}_{D L , k} ) = \frac{\vert {h}_{D L ,}^{H} {\hat{h}}_{D L , k} \vert}{‖ {h}_{D L , k} ‖ \cdot ‖ {\hat{h}}_{D L , k} ‖}$$

provided that a magnitude value of ∥αₖĥ_{DL,k}∥ (i.e., a form of channel magnitude in example I.1.1) is informed by NW.

Note that the cosine similarity is one of the popular loss functions being used in AI/ML-based algorithm in order to update parameters. Therefore, for example, once the UE computes the cosine similarities for all SBs as loss values, the UE reports those values (or gradient values corresponding to those values) to the NW, and the NW can update parameters of its own AI/ML-based algorithm based on the loss values.

In another example, a mean-squared error (MSE) can be used for loss function and the UE computes loss values based on the DL-RS measurement and/or target information. For example, for the MSE of SNR for loss function, the UE may compute it:

$$M S E ( {SNR}_{actual DL} , {SNR}_{inferred DL} ) = {( \frac{{‖ {h}_{D L , k} ‖}^{2}}{N} - \frac{{\vert {h}_{D L , k}^{H} {\hat{h}}_{D L , k} \vert}^{2}}{N} )}^{2}$$

where N is a noise power. Once the UE compute the loss function, the UE reports the loss value (or gradient corresponding to the loss value) to the NW to update its parameters in minimizing loss function. As an example, a relevant block diagram to update a deep neural network (DNN) in the NW through over-the-air (OTA) signaling is described in FIG. 20. As shown in FIG. 20, a mapping f₁(UL CH; θ₁) from UL channel to DL channel using a DNN can be trained using reported information from the UE, for example, an MSE of SNR between the SNR based on the actual DL channel and the SNR based on the inferred DL channel (or gradient value(s) of an MSE of SNR). Since the NW transmits N+1-port CSI-RS to the UE in this example, the UE can compute h_{DL,k} and

$${h}_{D L , k}^{H} {\hat{h}}_{D L , k}$$

to find the MSE of SNR between them, and report the MSE of SNR (or the gradient of it) to the NW.

In another embodiment, a UE is configured to perform DL RS reception with one antenna port for AI/ML training. In one example, a NW transmits beamformed DL RS (e.g., CSI-RS) where matched-filter (MF) beamforming is designed based on the inferred DL channel, i.e., vₖ=αₖĥ_{DL,k}, where αₖ is a power scaling factor, and the UE measures the beamformed CSI-RS and estimates the resultant DL channel

$${α}_{k} {h}_{D L , k}^{H} {\hat{h}}_{D L , k} .$$

Note that once the UE estimates

$${α}_{k} {h}_{D L , k}^{H} {\hat{h}}_{D L , k} ,$$

the UE can compute (approximate) cosine similarity between h_{DL,k} and ĥ_{DL,k} based on simple manipulation

$$( {h}_{D L , k} , {\hat{h}}_{D L , k} ) = \frac{\vert {h}_{D L , k}^{H} {\hat{h}}_{D L , k} \vert}{‖ {\hat{h}}_{D L , k} ‖ \cdot ‖ {\hat{h}}_{D L , k} ‖}$$

provided that a channel power value of ∥αₖ∥·∥ĥ_{DL,k}∥² (i.e., a form of channel power as described above) is informed by NW. Although ∥ĥ_{DL,k}∥ is used for the normalized factor for h_{DL,k} in the denominator instead of ∥h_{DL,k}∥, the (approximate) cosine similarity between h_{DL,k} and ĥ_{DL,k} can be utilized assuming ∥h_{DL,k}∥≈∥ĥ_{DL,k}∥. This embodiment is useful in terms of resource overhead for DL RS, since the DL RS only associates with one port (cf. N+1 ports in the previous embodiment).

In one embodiment, a UE computes loss value(s) (or gradient values of loss function) based on the DL RS measurement and target information, and performs reporting of information for (AI/ML) training. In one example, the training information in the report includes the loss value(s). In one example, the training information in the report includes DL CSI similar to CSI report. In another example, the training information in the report includes assistance information such as UE position, UE speed, and/or local information available at the UE. In one example, any combination of the above information is included in the training information of the report.

In one example, a loss value (or gradient values corresponding a loss value) is reported in a WB manner, i.e., one value is reported for all SBs in the configured reporting band (or CSI reporting band).

In one example, loss values (or gradient values corresponding loss values) are reported in a SB manner, i.e., one value is reported for each SB in the configured reporting band (or CSI reporting band).

In one example, loss values (or gradient values corresponding loss values) are reported in another frequency unit (other than SB) such as subcarrier or multiple of subcarriers, i.e., one value is reported for each frequency unit in the configured reporting band (or CSI reporting band).

In one example, loss values (or gradient values corresponding loss values) are selected from a set S comprising 2ⁿ^{ₐ} points in [0,1], where the set S is represented using a nₐ-bit indicator. In one example, nₐ-bit is fixed. In another example, nₐ-bit is configured via higher-layer parameter, MAC-CE, or DCI.
In one example, the set includes equidistance points in [0,1] in log-scale (dB-scale).
In one example, the set includes equidistance points in [0,1] in linear-scale.

In one example, the loss value is computed based on cosine similarity (e.g., as described above), which belongs to the interval [0,1].

In one example, loss values (or gradient values corresponding loss values) are selected from a set S comprising 2ⁿ^{ₐ} points in [−1,1], where the set S is represented using a nₐ-bit indicator. In one example, nₐ-bit is fixed. In another example, nₐ-bit is configured via higher-layer parameter, MAC-CE, or DCI.
In one example, the set includes 2ⁿ^{ₐ}⁻¹ equidistance points in [0,1] in log-scale (dB-scale) and the points that derive from −1 times 2ⁿ^{ₐ}⁻¹ equidistance points in [0,1] in log-scale (for getting the points in the interval [−1,0]).
In one example, the set includes equidistance points in [−1,1] in linear-scale.

In one embodiment, a UE is configured to report information for validation, and the UE computes loss value(s) or other metric based on the measured DL RS and target information, and performs reporting of information for validation. Based on a criterion, the UE determines the information in the reporting. In one example, the criterion is fixed or configured via higher-layer parameter, MAC-CE, or DCI. As an example, the criterion is given by that cosine similarity (or loss value) is greater than or equal to X_{TH}, where X_{TH}≤1 is a threshold value. In one example,

X_{TH} is fixed or configured.

In one example, the validation information in the report includes a 1-bit indicator to inform the loss value(s) is satisfied with a criterion or not. Optionally, if the loss value is not satisfied with the criterion, the validation information includes the loss value(s), where the loss value(s) is determined in examples of embodiments as described above.

In another example, the validation information in the report includes DL CSI similar to CSI report. In another example, the validation information in the report includes assistance information such as UE position, UE speed, and/or local information available at the UE. In one example, any combination of the above information is included in the validation information of the report.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a processor; and
a transceiver operably coupled with the processor, the transceiver configured to:
receive, from a base station, configuration information on a channel state information (CSI) report, wherein the configuration information includes information on CSI reference signal (CSI-RS) ports and a codebook associated with transmit and receive points (TRPs) and wherein CSI-RS resources associated with the CSI-RS ports correspond to the TRPs, and
transmit, to the base station, the CSI report including a bitmap,
wherein the bitmap includes at least one non zero bit for identifying coefficients in an amplitude coefficient indicator and a phase coefficient indicator,
wherein the CSI-RS resources correspond to the at least one non zero bit, and
wherein a number of the at least one non zero bit summed is based on a size of the bitmap.

2. The UE of claim 1, wherein each bit in the bitmap is for a layer, a spatial domain (SD) basis vector, a frequency domain (FD) basis vector, and one of the CSI-RS resources.

3. The UE of claim 1, wherein the each bit in the bitmap for a layer l=1, . . . , v is given by:
$${i}_{1 , 7 , l} = [ {k}_{l , 0}^{( 3 )} … {k}_{l , {M}_{υ - 1}}^{( 3 )} ] \\ {k}_{l , f}^{( 3 )} = [ {k}_{l , 0 , f}^{( 3 )} … {k}_{l , 2 {L}_{r} - 1 , f}^{( 3 )} ] \\ {k}_{l , i , f}^{( 3 )} = [ {k}_{l , i , f , 1}^{( 3 )} … {k}_{l , i , f , N}^{( 3 )} ] \\ {k}_{l , i , f , r}^{( 3 )} ∈ \{ 0 , 1 \}$$
where for an r-th CSI-RS resource:
Lᵣ is a number of spatial domain, SD, basis vectors,
Mᵥ is a number of frequency domain, FD, basis vectors,
v is a number of layers,
i=0, 1, . . . , 2Lᵣ−1, and
f=0,1, . . . , Mᵥ−1.

4. The UE of claim 1, wherein:
a number of the at least one non zero bit summed for a layer is given by
$${K}_{1 , l} = {\sum }_{r = 1}^{N} {\sum }_{i = 0}^{2 {L}_{r} - 1} {\sum }_{f = 0}^{{M}_{υ} - 1} {k}_{l , i , f , r}^{( 3 )} \leq {K}_{0}$$
for layer l=1, . . . , v, where a constrained value of K₀ is given by
$${K}_{0} = ⌈ β 2 {M}_{1} {\sum }_{r = 1}^{N} {L}_{r} ⌉ ,$$
and
a number of the at least one non zero bit summed for all layers is 2K₀, and is given by
$${\sum }_{l = 1}^{v} {K}_{1 , l} \leq 2 {K}_{0} .$$

5. The UE of claim 1, wherein:
the CSI report includes at least one CSI-RS resource selected from the CSI-RS resources, and
the CSI-RS ports include at least one group of CSI-RS ports.

6. A base station comprising:
a processor; and
a transceiver operably coupled to the processor, the transceiver configured to:
transmit, to user equipment (UE), configuration information on a channel state information (CSI) report, wherein the configuration information includes information on CSI reference signal (CSI-RS) ports and a codebook associated with transmit and receive points (TRPs) and wherein CSI-RS resources associated with the CSI-RS ports correspond to the TRPs, and
receive, from the UE, the CSI report including a bitmap,
wherein the bitmap includes at least one non zero bit for identifying coefficients in an amplitude coefficient indicator and a phase coefficient indicator,
wherein the CSI-RS resources correspond to the at least one non zero bit, and
wherein a number of the at least one non zero bit summed is based on a size of the bitmap.

7. The base station of claim 6, wherein each bit in the bitmap is for a layer, a spatial domain (SD) basis vector, a frequency domain (FD) basis vector, and one of the CSI-RS resources.

8. The base station of claim 6, wherein the each bit in the bitmap for a layer l=1, . . . , v is given by:
$${i}_{1 , 7 , l} = [ {k}_{l , 0}^{( 3 )} … {k}_{l , {M}_{υ - 1}}^{( 3 )} ] \\ {k}_{l , f}^{( 3 )} = [ {k}_{l , 0 , f}^{( 3 )} … {k}_{l , 2 {L}_{r} - 1 , f}^{( 3 )} ] \\ {k}_{l , i , f}^{( 3 )} = [ {k}_{l , i , f , 1}^{( 3 )} … {k}_{l , i , f , N}^{( 3 )} ] \\ {k}_{l , i , f , r}^{( 3 )} ∈ \{ 0 , 1 \}$$
where for an r-th CSI-RS resource:
Lᵣ is a number of spatial domain, SD, basis vectors,
Mᵥ is a number of frequency domain, FD, basis vectors,
v is a number of layers,
i=0, 1, . . . , 2Lᵣ−1, and
f=0,1, . . . , Mᵥ−1.

9. The base station of claim 6, wherein:
a number of the at least one non zero bit summed for all layers is given by
$${K}_{1 , l} = {\sum }_{r = 1}^{N} {\sum }_{i = 0}^{2 {L}_{r} - 1} {\sum }_{f = 0}^{{M}_{υ} - 1} {k}_{l , i , f , r}^{( 3 )} \leq {K}_{0}$$
for layer l=1, . . . , v, where a constrained value of K₀ is given by
$${K}_{0} = ⌈ β 2 {M}_{1} {\sum }_{r = 1}^{N} {L}_{r} ⌉ ,$$
and
a number of the at least one non zero bit summed for all layers is 2K₀, and is given by
$${\sum }_{l = 1}^{v} {K}_{1 , l} \leq 2 {K}_{0} .$$

10. The base station of claim 6, wherein:
the CSI report includes at least one CSI-RS resource selected from the CSI-RS resources, and
the CSI-RS ports include at least one group of CSI-RS ports.

11. A method performed by a user equipment (UE) in wireless communication system, the method comprising:
receiving, from a base station, configuration information on a channel state information (CSI) report, wherein the configuration information includes information on CSI reference signal (CSI-RS) ports and a codebook associated with transmit and receive points (TRPs) and wherein CSI-RS resources associated with the CSI-RS ports correspond to the TRPs; and
transmitting, to the base station, the CSI report including a bitmap,
wherein the bitmap includes at least one non zero bit for identifying coefficients in an amplitude coefficient indicator and a phase coefficient indicator,
wherein the CSI-RS resources correspond to the at least one non zero bit, and
wherein a number of the at least one non zero bit summed is based on a size of the bitmap.

12. The method of claim 11, wherein each bit in the bitmap is for a layer, a spatial domain (SD) basis vector, a frequency domain (FD) basis vector, and one of the CSI-RS resources.

13. The method of claim 11, wherein the each bit in the bitmap for a layer l=1, . . . , v is given by:
$${i}_{1 , 7 , l} = [ {k}_{l , 0}^{( 3 )} … {k}_{l , {M}_{υ - 1}}^{( 3 )} ] \\ {k}_{l , f}^{( 3 )} = [ {k}_{l , 0 , f}^{( 3 )} … {k}_{l , 2 {L}_{r} - 1 , f}^{( 3 )} ] \\ {k}_{l , i , f}^{( 3 )} = [ {k}_{l , i , f , 1}^{( 3 )} … {k}_{l , i , f , N}^{( 3 )} ] \\ {k}_{l , i , f , r}^{( 3 )} ∈ \{ 0 , 1 \}$$
where for an r-th CSI-RS resource:
Lᵣ is a number of spatial domain, SD, basis vectors,
Mᵥ is a number of frequency domain, FD, basis vectors,
v is a number of layers,
i=0, 1, . . . , 2Lᵣ−1, and
f=0,1, . . . , Mᵥ−1.

14. The method of claim 11, wherein:
a number of the at least one non zero bit summed for a layer is given by
$${K}_{1 , l} = {\sum }_{r = 1}^{N} {\sum }_{i = 0}^{2 {L}_{r} - 1} {\sum }_{f = 0}^{{M}_{υ} - 1} {k}_{l , i , f , r}^{( 3 )} \leq {K}_{0}$$
for layer l=1, . . . , v, where a constrained value of K₀ is given by
$${K}_{0} = ⌈ β 2 {M}_{1} {\sum }_{r = 1}^{N} {L}_{r} ⌉ ,$$
and
a number of the at least one non zero bit summed for all layers is 2K₀, and is given by
$${\sum }_{l = 1}^{v} {K}_{1 , l} \leq 2 {K}_{0} .$$

15. The method of claim 11, wherein:
the CSI report includes at least one CSI-RS resource selected from the CSI-RS resources, and
the CSI-RS ports include at least one group of CSI-RS ports.
